(19) United States
(12) Patent Application Publication
(10) Pub. No.: US 2026/0111912 A1
(43) Pub. Date: Apr. 23, 2026

(54) REAL-TIME EMISSION LEVEL DETERMINATION OF POWER PLANTS

(71) Applicant: International Business Machines Corporation, Armonk, NY (US)

(72) Inventors: Kamal Chandra Das, New Delhi (IN); Devyani Lambhate, Bangalore (IN); Ayush Jain, Lucknow (IN); Jagabondhu Hazra, Bangalore (IN); Manikandan Padmanaban, Chennai (IN); Hendrik F. Hamann, Bedford, NY (US); Ranjini Bangalore Guruprasad, Bangalore (IN)

(21) Appl. No.: 18/923,080

(22) Filed: Oct. 22, 2024

(51) Int. Cl. G06Q 30/018

(52) U.S. Cl. CPC G06Q 30/018

(57) ABSTRACT

Determination of emission levels of power plants includes receiving image data associated with images of a geographical region including a specific power plant. A first emission level of a gas indicating a total amount of the gas present in the geographical region is generated based on the image data. A second emission level of an emission of the gas by the specific power plant within a first predefined time period is generated based on the first emission level. A third emission level for each of the second predefined time periods within the first predefined time period is determined based on the second emission level. A calibration factor data is determined for each time period of the plurality of second predefined time periods based on the third emission level. A fourth emission level at each of the time instants is estimated based on the calibration factor data.

### BACKGROUND

The present disclosure relates to emission profiling and, more particularly, to estimating real-time emissions of power plants.

In recent years, rapid industrialization and rising global energy demands have led to a significant increase in the number of power plants and industrial facilities. While these facilities are crucial for economic development, they also contribute to air pollution and greenhouse gas emissions. Pollutants such as carbon dioxide (CO₂), sulfur oxides (SOₓ), nitrogen oxides (NOₓ), and particulate matter have been directly linked to environmental issues including global warming, acid rain, and respiratory health problems.

This growing concern over environmental pollution and its impact on climate change has intensified the need for effective monitoring and control of greenhouse gas emissions. Accurate measurement of greenhouse gas emissions is utilized for ensuring compliance with environmental regulations, implementing pollution control measures, and developing strategies to mitigate their harmful effects on the environment.

### SUMMARY

According to an embodiment of the present disclosure, a computer-implemented method for determination of real-time emission levels of power plants is described. The computer-implemented method includes receiving, by a computer, image data associated with a plurality of images of a geographical region. The geographical region includes a specific power plant. The image data indicates emission data associated with a gas. The computer-implemented method further includes generating, by the computer using a first artificial intelligence (AI) model, a first emission level associated with the gas based on the image data. The first emission level indicates a total amount of the gas present in the geographical region. The computer-implemented method further includes generating, by the computer using a second AI model, a second emission level based on the first emission level. The second emission level is associated with an emission of the gas by the specific power plant within a first predefined time period based on the first emission level. The computer-implemented method further includes generating, by the computer, a third emission level based on the second emission level. The third emission level is associated with an emission of the gas by the specific power plant within each of a plurality of second predefined time periods. The first predefined time period includes the plurality of the second predefined time periods. The computer-implemented method further includes determining, by the computer using a third AI model, calibration factor data based on the third emission level associated with each time period of the plurality of second predefined time periods, the calibration factor data is associated with the emission of the gas by the specific power plant within the first predefined time period. The calibration factor data includes a plurality of calibration values corresponding to a plurality of time instants within the first predefined time period. The computer-implemented method further includes estimating, by the computer, a fourth emission level based on the calibration factor data, the fourth emission level is associated with the emission of the gas by the specific power plant at each time instant of the plurality of time instants.

According to an embodiment of the present disclosure, a computer system for determination of real-time estimation level of the specific power plant is described. The computer system includes a processor set, one or more computer-readable storage media, and program instructions stored on the one or more computer-readable storage media, the program instructions executable by the processor set to cause the processor set to receive image data associated with a plurality of images of a geographical region. The geographical region includes a specific power plant. The image data indicates emission data associated with a gas, location data associated with the plurality of images, and a timestamp associated with the plurality of images. Further, the program instructions cause the processor set to reconfigure a first artificial intelligence (AI) model based on the image data and a loss function associated with the image data. Further, the program instructions cause the processor set to generate a first emission level associated with the gas based on an application of the first AI model on the image data. The first emission level indicates the total amount of the gas present in the geographical region. Further, the program instructions cause the processor set to generate a second emission level based on an application of a second AI model on the first emission level, the second emission level is associated with an emission of the gas by the specific power plant within a first predefined time period. Further, the program instructions cause the processor set to generate a third emission level based on the second emission level, the third emission level is associated with the emission of the gas by the specific power plant within each time period of a plurality of second predefined time periods. The first predefined time period includes the plurality of the second predefined time periods. Further, the program instructions cause the processor set to determine calibration factor data based on an application of a third AI model on the third emission level associated with each time period of the plurality of second predefined time periods, the calibration factor data is associated with the emission of the gas by the specific power plant within the first predefined time period. The calibration factor data includes a plurality of calibration values that correspond to a plurality of time instants within the first predefined time period. Further, the program instructions cause the processor set to estimate a fourth emission level based on the calibration factor data, the fourth emission level is associated with the emission of the gas by the specific power plant at each time instant of the plurality of time instants.

According to an embodiment of the present disclosure, a computer program product for estimation of emission levels associated with emission of a gas by power plants is described. The computer program product includes one or more computer-readable storage media and program instructions stored on the one or more computer-readable storage media to perform operations including receiving image data associated with a plurality of images of a geographical region. The geographical region includes a specific power plant. The image data indicates emission data associated with the gas. The operations further include generating a first emission level associated with the gas based on an application of a first artificial intelligence (AI) model on the image data. The first emission level indicates a total amount of the gas present in the geographical region. The operations further include generating a second emission level based on an application of a second AI model on the first emission level, the second emission level is associated with an emission of the gas by the specific power plant within a first predefined time period. The operations further include generating a third emission level based on the second emission level. The third emission level is associated with an emission of the gas by the specific power plant within each time period of a plurality of second predefined time periods. The first predefined time period includes the plurality of the second predefined time periods. The operations further include determining calibration factor data based on an application of a third AI model on the third emission level associated with each time period of the plurality of second predefined time periods, the calibration factor data is associated with the emission of the gas by the specific power plant within the first predefined time period. The calibration factor data includes a plurality of calibration values that correspond to a plurality of time instants within the first predefined time period. The operations further include estimating a fourth emission level based on the calibration factor data. The fourth emission level is associated with the emission of the gas by the specific power plant at each time period of the plurality of time instants.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for determination of real-time emission level of power plants, in accordance with an embodiment of the disclosure;

FIG. 2 is a diagram that illustrates a network environment in which a system for determination of real-time emission level of a specific power plant is implemented, in accordance with an embodiment of the disclosure;

FIG. 3A is a diagram that illustrates a block diagram of an exemplary operation for generating a first emission level associated using a first AI model, in accordance with an embodiment of the disclosure;

FIG. 3B is a diagram that illustrates a block diagram of an exemplary operation for segmentation of a plurality of images, in accordance with an embodiment of the disclosure;

FIG. 4 is a diagram that illustrates a block diagram of an exemplary operation for generating a third emission level, in accordance with an example embodiment of the present disclosure;

FIG. 5A is a diagram that illustrates a block diagram of an exemplary operation for determination of calibration factor data, in accordance with an example embodiment of the present disclosure;

FIG. 5B is a method flow diagram that illustrates an estimation of emission data associated with an emission of a gas by each of a set of power plants, in accordance with an embodiment of the disclosure;

FIG. 5C is a diagram that illustrates an exemplary operation for determination of the calibration factor data for one or more sets of power plants, in accordance with an example embodiment of the present disclosure;

FIG. 6A is a diagram that illustrates a network environment in which the system is implemented for determination of load emission data associated with a load, in accordance with an embodiment of the disclosure;

FIG. 6B is a diagram that illustrates a method flow for determination of the load emission data associated with the load, in accordance with an embodiment of the disclosure;

FIG. 7A is a block diagram that illustrates an exemplary operation for generation of a fourth emission level associated with emission of the gas by the specific power plant, in accordance with an embodiment of the disclosure;

FIG. 7B is a diagram that illustrates an exemplary operation for generation of the load emission data associated with the load, in accordance with an embodiment of the disclosure; and

FIG. 8 is a diagram that illustrates a flowchart of an exemplary method for estimating real-time emissions of the specific power plant, in accordance with an embodiment of the disclosure.

### DETAILED DESCRIPTION

According to an embodiment of the present disclosure, a computer-implemented method for the determination of real-time emission levels of power plants is described. The computer-implemented method includes receiving, by a computer, image data associated with a plurality of images of a geographical region. The geographical region includes a specific power plant, and the image data indicates emission data associated with a gas. The computer-implemented method further includes generating, by the computer using a first artificial intelligence (AI) model, a first emission level associated with the gas based on the image data. The first emission level indicates a total amount of the gas present in the geographical region. The computer-implemented method further includes generating, by the computer using a second AI model, a second emission level based on the first emission level. The second emission level is associated with an emission of the gas by the specific power plant within a first predefined time period based on the first emission level. The computer-implemented method further includes generating, by the computer, a third emission level based on the second emission level. The third emission level is associated with an emission of the gas by the specific power plant within each of a plurality of second predefined time periods. The first predefined time period includes the plurality of second predefined time periods. The computer-implemented method further includes determining, by the computer using a third AI model, calibration factor data based on the third emission level associated with each time period of the plurality of second predefined time periods, the calibration factor data is associated with the emission of the gas by the specific power plant within the first predefined time period. The calibration factor data includes a plurality of calibration values corresponding to a plurality of time instants within the first predefined time period. The computer-implemented method further includes estimating, by the computer, a fourth emission level based on the calibration factor data, the fourth emission level is associated with the emission of the gas by the specific power plant at each time instant of the plurality of time instants.

In an embodiment, the first AI model is a geospatial foundational model (GFM).

In an embodiment, the image data indicates location data associated with the plurality of images and a timestamp associated with the plurality of images, the computer-implemented method further includes reconfiguring, by the computer, the first AI model based on the image data and a loss function associated with the image data. The computer-implemented method further includes determining, by the computer using the first AI model, profile data associated with the specific power plant based on the image data. The profile data includes at least one of a type or a segmented area within the plurality of images associated with the specific power plant.

In an embodiment, the loss function is a morphological loss function. The morphological loss function is based on a structure of the specific power plant within the plurality of images.

In an embodiment, the computer-implemented method further includes inputting, by the computer to the third AI model, the profile data associated with the specific power plant. The computer-implemented method further includes inputting, by the computer to the third AI model, the third emission level within each time period of the plurality of second predefined time periods. The computer-implemented method further includes receiving, by the computer, ground truth emission data associated with the specific power plant. The computer-implemented method further includes inputting, by the computer to the third AI model, the ground truth emission data. The computer-implemented method further includes determining, by the computer using the third AI model, the calibration factor data based on the profile data, the third emission level, and the ground truth emission data.

In an embodiment, the computer-implemented method further includes receiving, by the computer, power plant data associated with each power plant of a plurality of power plants. The power plant data comprises imagery data of a geographical location associated with each power plant of the plurality of power plants. The plurality of power plants is inclusive or exclusive of the specific power plant. The computer-implemented method further includes identifying, by the computer, a set of power plants from the plurality of power plants based on at least one similarity criterion between the power plant data associated with each power plant of the plurality of power plants and the profile data. The computer-implemented method further includes estimating, by the computer, emission data associated with the emission of the gas by each power plant of the set of power plants based on the calibration factor data.

In an embodiment, the computer-implemented method further includes receiving, by the computer, grid topology data associated with a power grid. The power grid is supplied by at least the specific power plant. The computer-implemented method further includes receiving, by the computer, power consumption data associated with a load. The load is connected to the power grid. The computer-implemented method further includes determining, by the computer using a fourth AI model, load emission data based on the grid topology data, the power consumption data, and the fourth emission level associated with the emission of the gas by the specific power plant at each time instant of the plurality of time instants. The load emission data is associated with the emission of the gas by the load.

In an embodiment, the power grid is connected to one or more power plants including the specific power plant. The computer-implemented method further includes determining, by the computer using the fourth AI model, distribution data associated with the load based on the grid topology data and the power consumption data. The distribution data indicates a distribution of a total amount of power consumed by the load over each power plant of the one or more power plants connected to the power grid. The computer-implemented method further includes determining, by the computer using the fourth AI model, the load emission data based on the distribution data and the fourth emission level associated with the emission of the gas by the specific power plant at each time instant of the plurality of time instants.

In an embodiment, the computer-implemented method further includes generating, by the computer, the third emission level using a dispersion model. The dispersion model is calibrated based on one or more environmental factors associated with the geographical region.

In an embodiment, the gas corresponds to at least one of Carbon dioxide (CO₂), Nitrogen dioxide (NO₂), or Sulphur dioxide (SO₂).

According to an embodiment of the present disclosure, a computer system for determination of real-time emission levels of power plants is described. The computer system includes a processor set, one or more computer-readable storage media, and program instructions stored on the one or more computer-readable storage media executable by the processor set to cause the processor set to receive image data associated with a plurality of images of a geographical region. The geographical region includes a specific power plant. The image data indicates emission data associated with a gas, location data associated with the plurality of images, and a timestamp associated with the plurality of images. Further, the program instructions cause the processor set to reconfigure a first artificial intelligence (AI) model based on the image data and a loss function associated with the image data. Further, the program instructions cause the processor set to generate a first emission level associated with the gas based on an application of the first AI model on the image data. The first emission level indicates the total amount of the gas present in the geographical region. Further, the program instructions cause the processor set to generate a second emission level based on an application of a second AI model on the first emission level, the second emission level is associated with an emission of the gas by the specific power plant within a first predefined time period. Further, the program instructions cause the processor set to generate a third emission level based on the second emission level, the third emission level is associated with the emission of the gas by the specific power plant within each time period of a plurality of second predefined time periods. The first predefined time period includes the plurality of the second predefined time periods. Further, the program instructions cause the processor set to determine calibration factor data based on an application of a third AI model on the third emission level associated with each time period of the plurality of second predefined time periods, the calibration factor data is associated with the emission of the gas by the specific power plant within the first predefined time period. The calibration factor data includes a plurality of calibration values that correspond to a plurality of time instants within the first predefined time period. Further, the program instructions cause the processor set to estimate a fourth emission level based on the calibration factor data, the fourth emission level is associated with the emission of the gas by the specific power plant at each time instant of the plurality of time instants.

In an embodiment, the first AI model is a geospatial foundational model (GFM).

In an embodiment, the loss function is a morphological loss function. The morphological loss function is based on a structure of the specific power plant within the plurality of images.

In an embodiment, the program instructions cause the processor set to determine profile data associated with the specific power plant based on an application of the first AI model on the image data. The profile data comprises at least one of a type, or a segmented area within the plurality of images associated with the specific power plant.

In an embodiment, the program instructions cause the processor set to input the profile data associated with the specific power plant to the third AI model. The program instructions cause the processor set to input the third emission level within each time period of the plurality of second predefined time periods to the third AI model. The program instructions cause the processor set to receive ground truth emission data associated with the specific power plant. The program instructions cause the processor set to input the ground truth emission data to the third AI model. The program instructions cause the processor set to determine the calibration factor data based on the application of the third AI model on the profile data, the third emission level, and the ground truth emission data.

In an embodiment, the program instructions cause the processor set to receive power plant data associated with each power plant of a plurality of power plants. The power plant data comprises imagery data of a geographical location associated with each power plant of the plurality of power plants. The plurality of power plants is inclusive or exclusive of the specific power plant. The plurality of power plants is inclusive or exclusive of the specific power plant. The program instructions cause the processor set to identify a set of power plants from the plurality of power plants based on at least one similarity criterion between the power plant data associated with each power plant of the plurality of power plants and the profile data. The program instructions cause the processor set to estimate emission data associated with the emission of the gas by each power plant of the set of power plants based on the calibration factor data.

In an embodiment, the program instructions cause the processor set to receive grid topology data associated with a power grid. The power grid is supplied by at least the specific power plant. The program instructions cause the processor set to receive power consumption data associated with a load. The load is connected to the power grid. The program instructions cause the processor set to determine load emission data based on an application of a fourth AI model on the grid topology data, the power consumption data, and the fourth emission level associated with the emission of the gas by the specific power plant at each time instant of the plurality of time instants. The load emission data is associated with the emission of the gas by the load.

In an embodiment, the power grid is connected to one or more power plants comprising the specific power plant. The program instructions cause the processor set to determine distribution data associated with the load based on an application of the fourth AI model on the grid topology data and the power consumption data. The distribution data indicates a distribution of a total amount of power consumed by the load over each power plant of the one or more power plants connected to the power grid. The program instructions cause the processor set to determine the load emission data based on an application of the fourth AI model on the distribution data and the fourth emission level associated with the emission of the gas by the specific power plant at each time instant of the plurality of time instants.

In an embodiment, the program instructions cause the processor set to generate the third emission level based on an application of a dispersion model. The dispersion model is calibrated based on one or more environmental factors associated with the geographical region.

According to an embodiment of the present disclosure, a computer program product for estimation of emission levels associated with emission of a gas by power plants is described. The computer program product includes one or more computer-readable storage media and program instructions stored on the one or more computer-readable storage media to perform operations including receiving image data associated with a plurality of images of a geographical region. The geographical region includes a specific power plant. The image data indicates emission data associated with the gas. The operations further include generating a first emission level associated with the gas based on an application of a first artificial intelligence (AI) model on the image data. The first emission level indicates a total amount of the gas present in the geographical region. The operations further include generating a second emission level based on an application of a second AI model on the first emission level, the second emission level is associated with an emission of the gas by the specific power plant within a first predefined time period. The operations further include generating a third emission level based on the second emission level. The third emission level is associated with an emission of the gas by the specific power plant within each time period of a plurality of second predefined time periods. The first predefined time period includes the plurality of the second predefined time periods. The operations further include determining calibration factor data based on an application of a third AI model on the third emission level associated with each time period of the plurality of second predefined time periods, the calibration factor data is associated with the emission of the gas by the specific power plant within the first predefined time period. The calibration factor data includes a plurality of calibration values that correspond to a plurality of time instants within the first predefined time period. The operations further include estimating a fourth emission level based on the calibration factor data. The fourth emission level is associated with the emission of the gas by the specific power plant at each time period of the plurality of time instants.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

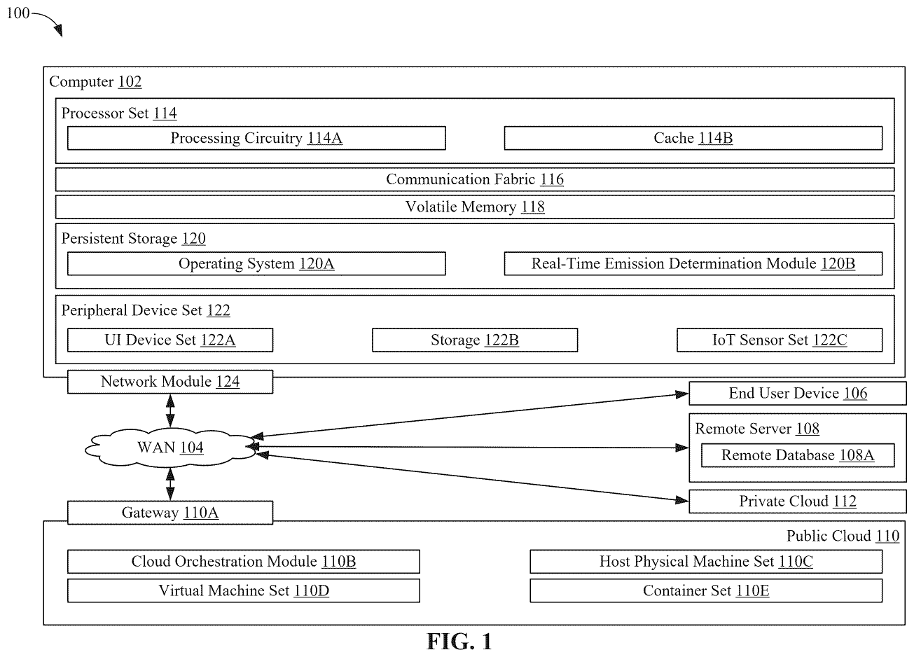

FIG. 1 is a diagram that illustrates a computing environment 100 for determination of real-time emission levels of power plants, in accordance with an embodiment of the disclosure. The diagram contains an exemplary environment for execution of at least one module involved in performing the methods, such as a real-time emission determination module 120B associated with the automated tagging of the service requests. In addition to the real-time emission determination module 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the real-time emission determination module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the real-time emission determination module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The real-time emission determination module 120B typically includes the at least one module involved in performing the methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in an embodiment of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

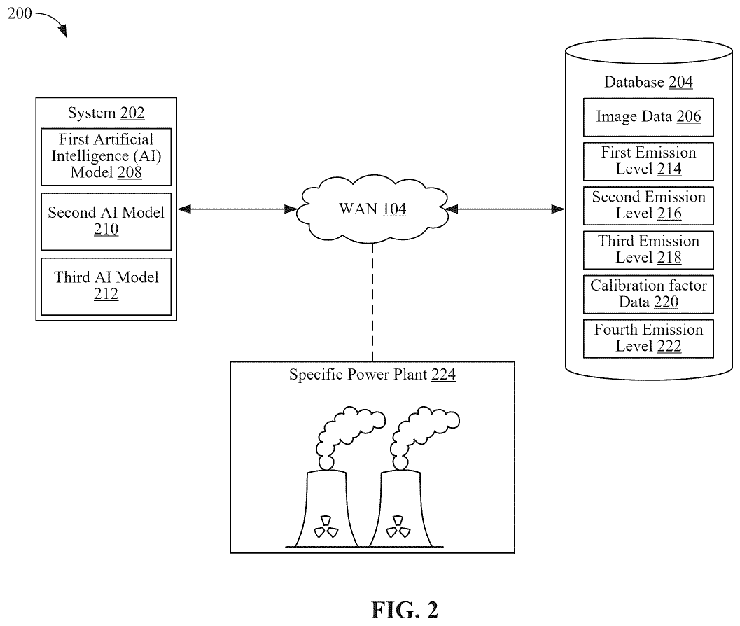

FIG. 2 is a diagram that illustrates a network environment 200 in which a system 202 for determination of a real-time emission level of a specific power plant 224 is implemented, in accordance with an embodiment of the disclosure. FIG. 2 is explained in conjunction with elements from FIG. 1. The network environment 200 includes the system 202, a database 204. The system 202 includes a first AI model, a second AI model, and a third AI model. The database 204 includes image data 206, a first emission level 214, a second emission level 216, a third emission level 218, calibration factor data 220, and a fourth emission level 222. The network environment 200 further includes the WAN 104 of FIG. 1. In an embodiment, the system 202 may be an exemplary embodiment of the computer 102 of FIG. 1.

The system 202 may include suitable logic, circuitry, interfaces, and/or code that may be configured for the determination of real-time emission levels of the specific power plant 224. The system 202 utilizes advanced machine learning algorithms to process large datasets, allowing for real-time analysis of emissions data. Additionally, the system 202 generates the calibration factor data 220 which is scalable to other power plants with similar profiles. By applying the calibration factors determined for one power plant to other power plants with comparable operational characteristics and environmental conditions, the system 202 provides reliable emissions estimates for a broader range of facilities. Moreover, the system's dynamic modeling capabilities enable it to disaggregate emissions data into sub-daily intervals, capturing fluctuations in emissions throughout the day. This level of detail is utilized for understanding the operational impacts of the power plant and for identifying trends over time. Finally, the system 202 enhances stakeholder engagement by providing transparent and accessible emissions data. This transparency fosters accountability and supports efforts to reduce greenhouse gas emissions, contributing to broader climate change mitigation initiatives.

In an embodiment, the database 204 corresponds to an organized collection of data that may be stored and accessed electronically from a computer system (such as the system 202). The database 204 is configured to manage, store, retrieve, and update data efficiently. In an exemplary implementation, the structure of the database 204 typically involves tables, records, and fields that can be managed through various database management systems (DBMS). Examples of the database 204 include but are not limited to, a relational database, a Non-Structured Query Language (SQL) database, a hierarchical database, a network database, a transactional database, a data warehouse, and a distributed database. In an exemplary embodiment, the database 204 is configured to store the image data 206 obtained from various sources, including, but not limited to, satellites and aerial vehicles, such as drones. This allows the database 204 to collect and organize a wide range of geospatial data is utilized for analysis. Additionally, the database 204 is configured to retain intermediate outputs generated by the system 202, such as results from each of the AI models utilized in the system 202. By storing these outputs, the database 204 provides efficient data management and retrieval, enabling seamless access to critical information for further analysis and decision-making. This structured storage approach enhances the system's ability to track changes over time, compare results across different models, and refine emissions estimates based on the latest data inputs.

The first AI model 208 analyzes the image data 206 associated with a geographical region and determines a total amount of gas, referred to as the first emission level 214, present in the geographical region. The first AI model 208 utilizes the image data 206 associated with a plurality of images such as, but not limited to, satellite images, aerial photos, or any other visual or spectral data. Further, the first AI model 208 is configured to detect the first emission level 214 of the gas present in the geographical region. In an example, the first AI model 208 is a geospatial foundational model (GFM). The first AI model 208 utilizes various techniques such as, but not limited to, image segmentation, object detection, and feature extraction to identify the emission source i.e., the specific power plant 224 in the plurality of images. Further, the first AI model 208 utilizes spectral analysis to measure the gas concentration based on a wavelength reflected or absorbed by the gas.

The second AI model 210 is configured to estimate the amount of gas that is being emitted by the specific power plant 224 within the geographical region within a first emission time period. The first AI model 208 is configured to determine the amount of gas present in the geographical region and the second AI model 210 isolates the amount of emission of the gas in the geographical region with respect to the specific power plant 224. The second AI model 210 utilizes factors such as, but not limited to, a location of the specific power plant 224, the specific power plant 224 operation schedule, and other contextual factors for example, wind speed, and humidity in the geographical region. Further, the second AI model 210 is configured to determine the second emission level 216 associated with the emission of gas by the specific power plant 224. The second AI model 210 utilizes various techniques such as, but not limited to, time-series forecasting, regression analysis, and spatiotemporal models.

The third AI model 212 utilizes various techniques such as, but not limited to, calibration algorithms, sensor fusion techniques, data correction techniques, and advanced regression models. The third AI model 212 is configured to estimate the emission, referred to as the fourth emission level 222, of the gas based on the calibration factor data 220. The third AI model 212 utilizes a combination of inputs, including the third emission level 218 of the emission of the gas from the specific power plant 224, the calibration factor data 220, profile data related to the plant's characteristics, and ground truth emission data. In an example, the third AI model 212 employs algorithms to analyze these variables. Based on calibration values that correspond to various time instants, the third AI model 212 determines a detailed temporal analysis of the emission of the gas within the geographical region, for adjustments in future predictions based on real-world measurements.

In an embodiment, the geographical region represents a distinct area of land and/or a combination of land and water characterized by specific features that differentiate it from surrounding areas. These defining characteristics may be, for example, specific power plant 224 boundary characteristics. The geographical region may correspond to a defined location on the Earth's surface, i.e., covering a specific spatial extent. The geographical region exhibits relative homogeneity in terms of shared characteristics, which can be either natural or human-made, and have boundaries that may be clearly defined or transitional, where the characteristics blend into other regions.

The term “power plant” refers to an industrial facility that generates electricity by converting various forms of energy into electrical power. The power plant provides the energy required for lighting, heating, cooling, and powering appliances and machinery in homes, businesses, and industries. Power plants typically include a power source, such as fossil fuels (coal, natural gas, or oil), nuclear energy, or renewable sources (solar, wind, hydroelectric, or geothermal), a generator that converts mechanical energy into electrical energy, a turbine driven by the power source's energy, and a control system that regulates and manages the plant's operations. The process of generating electricity in a power plant begins with the activation of the energy source. In fossil fuel plants, this involves burning coal or natural gas, while nuclear plants trigger controlled nuclear reactions. Renewable sources like sunlight or wind provide energy directly. The generated heat is then used to produce steam in a boiler or steam generator, which drives the turbine connected to the generator. As the turbine spins, it causes the generator's coil to rotate within a magnetic field, inducing a flow of electric current and converting mechanical energy into electrical energy. The power plants can be classified based on their energy source (fossil fuel, nuclear, or renewable), their size (small-scale or large-scale), or their duty (base load, intermediate load, or peak load).

In operation, the system 202 is configured to receive the image data 206 associated with the plurality of images of the geographical region. In an example, the image data 206 corresponds to multi-spectral images of the geographical region. The image data may indicate information about a location, a shape, and characteristics of various features on the earth's surface, including landforms, infrastructure, and natural resources associated with the geographical region having the specific power plant 224. The image data 206 is obtained through various mediums such as, but not limited to, satellite observation, aerial photography, or other imaging techniques that capture a visual or spectral representation of the geographical region. In an example, each of the plurality of images corresponds to an image of an atmosphere over the geographical region. Further, the geographical region comprises the specific power plant 224.

Moreover, the image data 206 indicates emission data associated with the gas. In an example, each of the plurality of images may be a multispectral image of the geographical region. The multispectral image is captured across a plurality of wavelength ranges in the electromagnetic spectrum, allowing for the extraction of information. Multispectral imaging employs several spectral bands, typically ranging from 4 micrometer (μm) to 15 me, to gather detailed data about the properties of the atmosphere in the geographical region at different wavelengths. These different wavelengths may indicate characteristics of different gasses present in the atmosphere in the geographical region. The multispectral images are captured using specialized cameras or sensors that separate light into distinct spectral bands, which can include visible light (0.4 to 0.7 μm), near-infrared (NIR; 0.7 to 1 μm), short-wave infrared (SWIR; 1 to 1.7 μm), mid-wave infrared (MWIR; 3.5 to 5 μm), and long-wave infrared (LWIR; 8 to 12 μm). The resulting image is captured as a series of monochrome grayscale images, with each image representing a specific wavelength range. The image data 206 indicates emission data associated with the gas. In an example, the gas may be, for example, carbon dioxide (CO₂), carbon monoxide (CO), sodium dioxide (SO₂), or nitrogen dioxide (NO₂). Subsequently, different spectral images corresponding to different spectrums may indicate emission levels of the different gases in the geographical region.

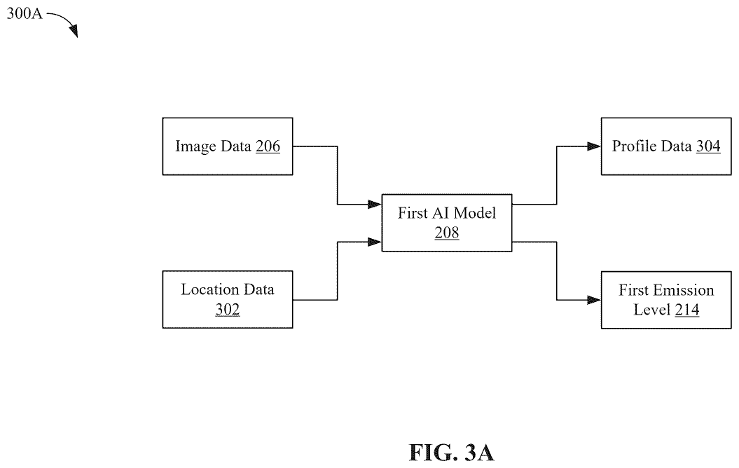

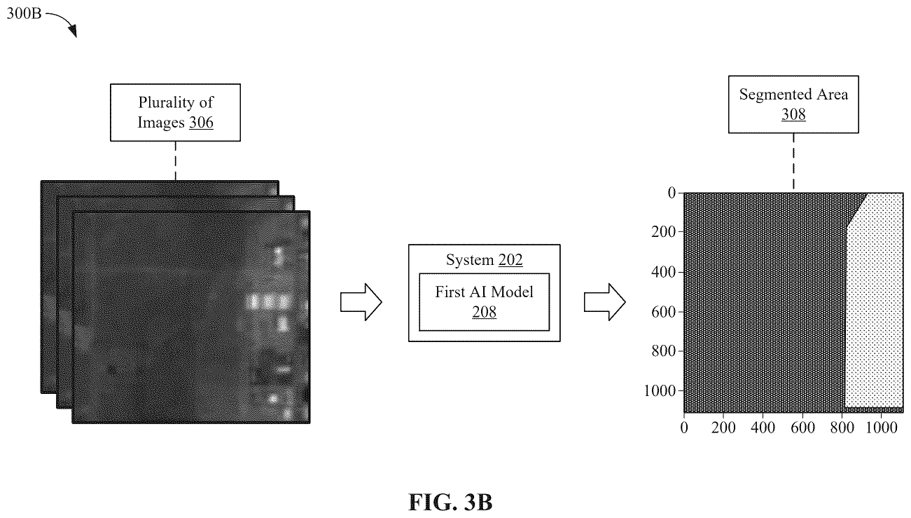

In an example, the system 202 is configured to reconfigure the first AI model 208 based on the image data 206 and a loss function associated with the image data 206. In an example, the system 202 utilizes a morphological loss function to fine-tune the pre-trained first AI model 208 for determining the first emission level 214 of the gas in the geographical region. In certain cases, the first AI model 208 may also determine profile data associated with the specific power plant 224. The profile data includes a type of power plant and a segmented area associated with the specific power plant 224. Further details associated with the profile data are described in conjunction with, for example, FIG. 3A.

Further, the first AI model 208 is configured to generate a first emission level 214 associated with the gas based on an application of the first AI model 208 on the image data 206. The first emission level 214 indicates the total amount of gas present in the geographical region. In an example, the system 202 utilizes advanced machine learning algorithms and geospatial analysis techniques, which interpret the image data 206 to quantify the emissions of the gas in the geographical region. This process involves identifying specific emission sources, such as smokestacks and cooling towers, and tracking the dispersion of pollutants in the atmosphere.

Moreover, the system 202 integrates the emission data with other contextual information, such as meteorological conditions and operational parameters, to enhance the accuracy and reliability of the emissions estimates. In an example the first AI model 208 is configured to determine the total amount of gas present in the geographical region. For example, the system 202 is configured to determine the first emission level 214 with respect to CO₂ present in the atmosphere of the geographical region. Similarly, in other examples, the system 202 is configured to determine the total amount of emission by the other gases, such as SO₂, CO, and NO₂.

To this end, the first emission level 214 of the gas in the environment of the geographical region indicates a total amount of the gas present in the geographical region. Such a total amount of emission may be attributed to the historical accumulation of the gas within the environment. The present disclosure describes techniques for determining the real-time emission level of the specific power plant 224 to accurately identify an amount of a gas released by the specific power plant 224 in the environment in real-time.

The system 202 is configured to generate the second emission level 216 associated with the emission of the gas by the specific power plant 224 within a first predefined time period based on the first emission level 214. The system 202 utilizes the second AI model 210 to generate the second emission level 216. In an embodiment, the system 202 is configured to identify the amount of gas emitted by the specific power plant 224 into the atmosphere in the first predefined time period. The system 202 generates the second emission level 216 within the first predefined time period, such as, but not limited to, a day, such as in 24 hours. The output of the second AI model 210 is the second emission level 216 associated with the emission of the gas by the specific power plant 224 within the first predefined time period, for example, a daily emission of CO₂ gas by the specific power plant 224.

In an example the second emission level 216 corresponds to the daily amount of CO₂ emitted by the specific power plant 224 in the geographical region. It is crucial to note that once the CO₂ enters the atmosphere, it takes millions of years to decompose fully. Furthermore, various factors, including wind speed and humidity, can influence the accuracy of estimation of CO₂ emission on a daily basis. The second AI model 210 generates the daily emission of CO₂ by the specific power plant 224. The second AI model 210 utilizes the image data 206 associated with other gases, such as, but not limited to, NO₂ and SO₂, to identify the relative emission of CO₂ by the specific power plant 224. In an example, the amount of CO₂ emitted by the specific power plant 224 in a single day is relatively small compared to the total amount of CO₂ present in the environment. To address this challenge, the second AI model 210 utilizes the image data 206 and the first emission level 214 to determine the emission of other gases and then uses the determined emission of other trace gases to calculate the relative amount of CO₂ emitted by the specific power plant 224 in a single day.

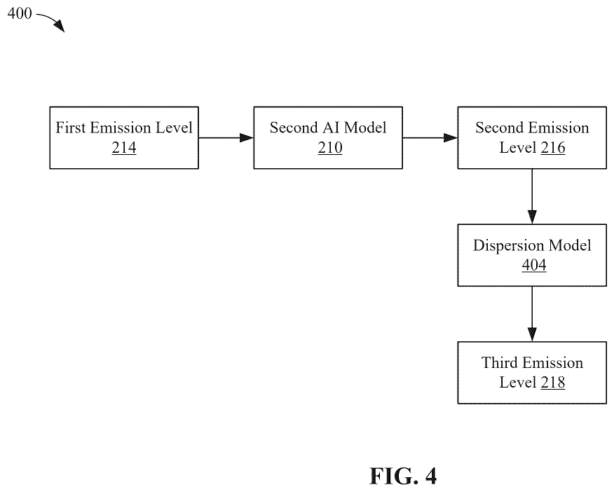

Further, the system 202 generates the third emission level 218 based on the second emission level 216. The third emission level 218 is associated with the emission of gas by the specific power plant 224 within each of a plurality of the second predefined time periods. The first predefined time period includes the plurality of the second predefined time period. In an embodiment, the system 202 utilizes a dispersion model to generate the third emission level 218 associated with the emission of the gas by the specific power plant 224 within each of the plurality of second predefined time periods. In an example, the plurality of second predefined time periods corresponds to different time windows, such as 1 hour time windows within the first predefined time period, such as 24 hours or a day. In an example, the system 202 is configured to generate the third emission level 218 associated with the emission of CO₂ by the specific power plant 224 within a sub-daily time period, i.e., each hour of the day based on uniform distribution of the second emission level 216 throughout the day. For instance, the system 202 may utilize the dispersion model such as, but not limited to, the Gaussian plume model to generate the third emission level 218 of CO₂ emitted by the specific power plant 224 in sub-daily time periods based on dividing the second emission level 216 over the first predefined time period, i.e., 24 hours. Details of the third emission level 218 are further described in conjunction with, for example, FIG. 4.

Further, the system 202 is configured to determine the calibration factor data 220 based on an application of a third AI model 212 on the third emission level 218 associated with each time period of the plurality of second predefined time periods. The calibration factor data 220 is associated with the emission of the gas by the specific power plant 224 at each of a plurality of time instants within the first predefined time period. In an example, the calibration factor data 220 comprises a plurality of calibration values that are continuously varying over each time instant of the first predefined time period. In an example, the system 202 utilizes the third AI model 212 to determine the calibration factor data 220 for accurate emission measurements from the specific power plant 224. The third AI model 212 processes data from the third emission level 218 over multiple predefined time periods. In other words, the system 202 utilizes the third AI model 212 to analyze the third emission level 218 for different second predefined time periods within the first predefined time period. The outcome of this analysis is the calibration factor data 220, which consists of multiple calibration values corresponding to distinct time instants within the first predefined time period. Each of the multiple calibration values are utilized for adjusting and aligning the emission measurements, ensuring they reflect the true emission levels of the specific power plant 224.

According to an example embodiment, the system 202 is configured to distribute the second emission level 216 uniformly over the second predefined time periods within the first predefined time period to determine the third emission level 218. In an example, the second emission level 216 indicates emissions by a specific power plant 224 in a day. Further, the system 202 is configured to distribute the second emission level 216 uniformly over each hour of a day to determine the third emission level 218 for each hour of a day. However, the specific power plant 224 may not produce a same amount of energy or burn a same amount of fuel throughout the day. For example, the specific power plant 224 may be producing more energy in the morning between 10:00 AM and 12:00 PM and at night between 19:00 PM and 23:00 PM. As a result, the uniform distribution, i.e., the third emission level 218, fails to accurately identify an amount of emission at each time instant, say at 12:00 PM or 15:45 PM, etc. of the day. Subsequently, the system 202 is configured to determine the calibration factor data 220. The calibration factor data 220 comprises a plurality of dynamic calibration values that are continuously varying over each time instant of the plurality of time instants within the first predefined time period. For example, the plurality of dynamic calibration values may be a set of values that vary in each time instant, say every 1 minute, 5 minutes, 10 minutes, 20 minutes, 30 minutes, etc. over the day.

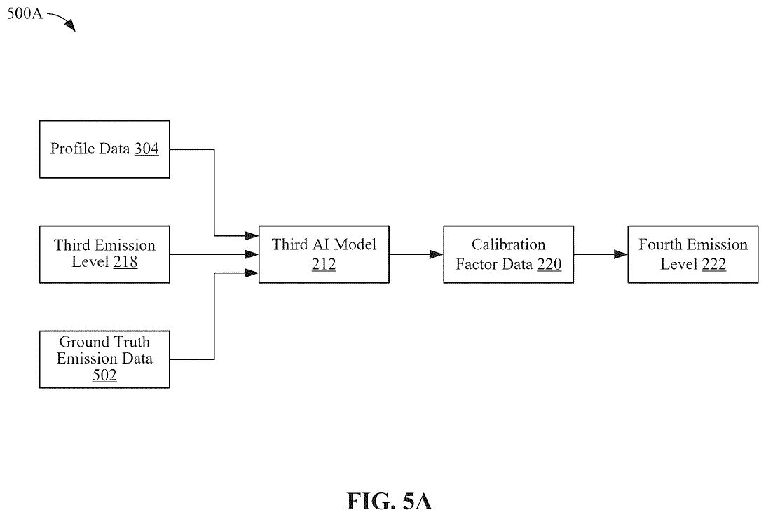

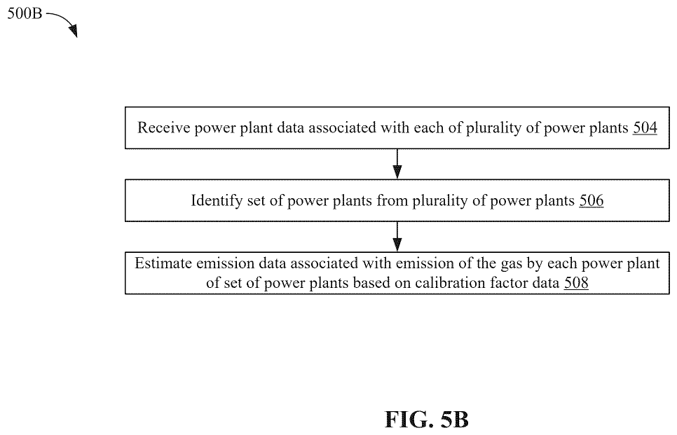

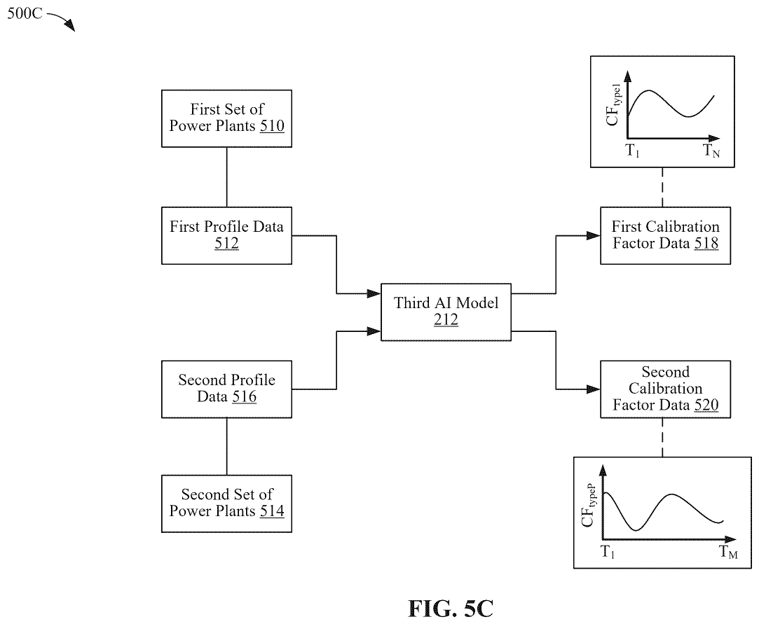

In an example, the third AI model 212 analyses various data inputs, including real-time emissions data, operational parameters, and environmental conditions, to produce a comprehensive assessment of gas emissions from the specific power plant 224. By leveraging advanced machine learning algorithms, the third AI model 212 identifies patterns and correlations that inform the emissions data. The calibration factor data 220 serves as an adjustment parameter that accounts for variations in emissions due to different operational conditions and measurement uncertainties. For example, if the third emissions data reveals significant fluctuations during specific operational phases or under varying weather conditions, the system 202 adjusts the calibration factor accordingly. The system 202 collects data from multiple sources, including historical emissions records and real-time monitoring data, to enhance the accuracy of the calibration factor data 220. By integrating this diverse dataset, the system 202 ensures that the calibration factor data 220 reflects the specific power plant 224 emissions profile accurately. Details of the calibration factor data 220 are described in conjunction with, for example, FIG. 5A.

In an exemplary embodiment, the system 202 is configured to generalize the calibration factor data 220 across different power plants with similar profiles. Since emission levels are unique to each power plant, the third emission level 218 measured for one plant cannot be directly used to assess emission of different power plants. Instead, the third AI model 212 determines the calibration factor data 220 based on the third emission level 218 and profile data of individual power plants. This data can then be applied to other power plants with comparable profiles, such as other power plants using the same type of fuel to produce electrical energy and/or producing the same or similar amount of energy, to achieve accurate emission level assessments.

Further, the system 202 is configured to estimate the fourth emission level 222 based on the calibration factor data 220. The fourth emission level 222 is associated with the emission of the gas by the specific power plant 224 at each of the plurality of time instants. In an embodiment, the system 202 estimates the fourth emission level 222 associated with the emission of gas by the specific power plant 224 at each of the plurality of time instants, using the calibration factor data 220 as a foundational input. Based on the fourth emission level 222, the system 202 adjusts the raw emissions estimates to reflect more accurately the actual emissions of the gas by the specific power plant 224 at each time instant. This adjustment accounts for variations in operational efficiency, environmental factors, and measurement uncertainties that may influence the emissions data.

In an example, if the specific power plant 224 operates with varying efficiency levels throughout the day due to changes in demand and fuel quality. During peak hours, the plant may emit more gas due to higher energy production. The system 202 uses the calibration factor data 220 to adjust the emissions estimates accordingly. If the calibration factor data 220 indicates that emissions are typically 20% higher during peak hours, the system 202 applies the calibration factor data 220 to the third emission level 218. As a result, if the third emission level 218 generated by the specific power plant 224 for a specific time instant is 100 tons of CO₂, the system 202 adjusts the third emission level 218 to the fourth emission level 222 to 120 tons by applying the calibration factor data 220. This refined estimate provides a more accurate representation of the specific power plant 224 emissions at that time instant.

FIG. 3A is a diagram that illustrates a block diagram 300A of an exemplary operation for generating the first emission level 214 using the first AI model 208, in accordance with an example embodiment of the present disclosure. In an example, the steps of the exemplary operation may be implemented by the system 202. FIG. 3A is described in conjunction with elements of the FIG. 2.

In one embodiment, the system 202 is configured to receive the image data 206 from the database 204. The image data 206 is associated with the plurality of images. Moreover, each of the plurality of images corresponds to a multispectral image of the geographical region. Each of the plurality of images includes the emission data of the one or more gases in the geographical region. The plurality of images corresponds to the amount of gas present in the atmosphere, environment, or a vertical column of the geographical region.

In one embodiment, the image data 206 indicates location data 302 associated with the plurality of images, and a timestamp associated with the plurality of images. In particular, the location data 302 each pixel of each of the plurality of images includes graded pixel data of the geographical region and includes location data and the timestamp. Subsequently, each image of the plurality of images may indicate a geographical location associated with the geographical region as well as a timestamp at which the image was captured. In addition, each image of the plurality of images may indicate a spectrum of a certain wavelength. The wavelength may be chosen based on the type of the gas for which emission levels are checked. In an example, the spectrum of a first wavelength in the image may indicate distribution of CO₂ in the atmosphere of the geographical region. This allows for precise tracing of gas concentrations over specific areas and time periods. In an example, each pixel of the plurality of images corresponds to the area such as, but not limited to, 2 square kilometers (Sq Km) of the earth's surface.

In an embodiment, spectrum(s) of wavelength(s) in an image indicates emission data. The emission data includes an amount of gas present in the geographical region. The multispectral images capture data across specific wavelength ranges in the electromagnetic spectrum, typically using 4-15 bands, allowing for the extraction of the emission data for one or more types of gasses and location and/or temporal data associated with each pixel of each of the plurality of images. Each spectral band captures one or more gases present in the atmosphere of the geographical region. For instance, an image from the plurality of images provides information on the CO₂ concentration in the atmosphere of the geographical region.

In an embodiment, the system 202 is configured to reconfigure the first AI model 208 based on the image data 206 and a loss function associated with the image data 206. In an example, the received image data 206 from database 204 is having quality issues. Sensors experience issues related to, but not limited to, data quality, including missing data, cloud cover interference, and sensor calibration problems. These factors significantly impact the reliability of the received image data 206. For instance, in some cases, as much as 90% of the Image data 206 may not meet quality control standards, leaving only a small fraction of usable information. To address these challenges, the system 202 is configured to fill in the gaps left by missing or low-quality data. In one embodiment, the system 202 is configured to reconfigure the first AI model 208, which leverages machine learning techniques to analyze and extrapolate the available data. By creating a continuous data stack that is regular in both space and time, the first AI model 208 is configured to enhance the quality and usability of the image data 206.

In one embodiment, the system 202 reconfigures the first AI model 208 based on the received image data 206. The first AI model 208 is reconfigured based on the location data 302, timestamps of the images, and the loss function associated with the image data 206. In an embodiment, the loss function is a morphological loss function. The morphological loss function is based on a structure of the specific power plant 224 within the plurality of images. The morphological loss function is configured to recognize and leverage specific shapes and structural characteristics of industrial facilities, such as the specific power plant 224 to reconfigure or fine-tune the first AI model 208. Different types of power plants exhibit unique shapes based on their fuel sources and operational designs, which can significantly influence their emissions profiles. For example, a coal-fired power plant may have a distinct layout compared to a natural gas facility, leading to variations in how emissions are released and dispersed.

In an embodiment, the morphological loss functions are specialized loss functions used in deep learning to enhance the performance of the first AI model 208. In particular, the morphological loss function is used in tasks involving shape and structure recognition. The morphological loss functions are designed to capture and utilize the unique morphological characteristics of objects within each of the plurality of images in the image data 206 and utilize the characteristics of objects for analyzing industrial facilities, such as the specific power plant 224. In the context of emissions monitoring, the morphological loss functions help the first AI model 208 to recognize distinct shapes associated with different types of power plants, which can vary based on their fuel sources and operational designs. For example, coal-fired power plants may have large smokestacks and expansive layouts, while natural gas plants may exhibit more compact designs. By incorporating these structural features into the modeling process, the first AI model 208 improves the accuracy of emissions profiling. The morphological loss functions facilitate the segmentation of images, allowing the first AI model 208 to differentiate between various industrial facilities and assess their emissions more precisely.

The system 202 is configured to determine, using the first AI model 208, profile data 304 associated with the specific power plant 224 based on the image data 206. The profile data 304 associated with the specific power plant 224 includes at least one a type, or a segmented area within the plurality of images associated with the specific power plant 224. In an example, the system 202 is configured to determine profile data 304 associated with the specific power plant 224 in the geographical region by utilizing both image data 206, the location data 302, the timestamps and the loss function. In an example, the first AI model 208 generates detailed insights into the specific power plant 224 characteristics and emissions based on the image data 206. The profile data 304 generated by the system 202 includes the type of power plant and the segmented area within the plurality of images associated with the specific power plant 224. For instance, the system 202 identifies whether the specific power plant 224 is coal-fired, natural gas, or renewable energy-based, such as a solar, hydro, or wind facility. This classification is needed for understanding the specific emissions profile and operational characteristics of the specific power plant 224. Additionally, the segmented area within the plurality of images provides spatial information about layout and structure of the specific power plant 224. By analyzing the plurality of images, the system 202 delineates different sections of the facility, such as the turbine area, fuel storage, and emission stacks. The segmentation allows the system 202 for a more granular analysis of emissions sources, enabling the identification of specific areas that may require monitoring or intervention. For example, if the system 202 processes images of a coal-fired power plant, the system 202 is configured to segment the areas associated with coal storage and combustion, providing insights into where emissions are likely to be highest.

In an exemplary embodiment, the first AI model 208 is configured to generate the first emission level 214. In an example, the system 202 generates XCO₂, which represents a column-average concentration of carbon dioxide, providing a measure of how much CO₂ is present in a vertical column of the atmosphere above the geographical region at a particular time of a day.

FIG. 3B is a diagram that illustrates a block diagram 300B of an exemplary operation for segmentation of a plurality of images 306, in accordance with an example embodiment of the present disclosure. In an example, the steps of the exemplary operation may be implemented by the system 202. FIG. 3B is described in conjunction with elements of the FIG. 2, and FIG. 3A.

In an exemplary embodiment, the system 202 is configured to receive the plurality of images 306. The plurality of images 306 is associated with the geographical region and may include representation of the specific power plant 224. Each of the plurality of images 306 may provide unique information about gases present in the atmosphere around the specific power plant 224 in the geographical region. However, in some instances, the boundaries of the specific power plant 224 may not be visible within the plurality of images 306. This lack of visibility can occur due to various factors, such as environmental conditions, obstructions, or the resolution of the images.

The first AI model 208 utilizes advanced image segmentation techniques to partition the plurality of images 306 into meaningful segments or regions. Each segmented area corresponds to specific characteristics, such as structural components of the specific power plant 224 or the facility, a type of gas emitted, etc. For example, the segmentation may reveal distinct areas related to the coal storage, combustion units, and emission stacks of a coal-fired power plant. By analyzing the segmented area 308, the system 202 determines the emissions profile of the facility, identifying which areas contribute most significantly to greenhouse gas emissions.

The segmentation process also incorporates location data 302, allowing the system 202 to correlate the segmented area with specific geographical coordinates. The segmented area 308 refers to specific regions identified within images, particularly in the context of analyzing emissions from industrial facilities like the specific power plant 224. By utilizing the first AI model 208, the segmented area 308 is delineated based on distinct features, such as structural components and emission sources. For instance, in a specific power plant 224, the segmented area 308 may include coal storage, combustion units, and emission stacks. This segmentation enables precise monitoring of gas emissions and facilitates targeted environmental assessments.

FIG. 4 is a diagram that illustrates a block diagram 400 of an exemplary operation for generating the third emission level 218, in accordance with an example embodiment of the present disclosure. In an example, the steps of the exemplary operation may be implemented by the system 202. FIG. 4 is described in conjunction with elements of the FIG. 2, FIG. 3A and FIG. 3B.

In one embodiment, the second AI model 210 is configured to receive the first emission level 214 associated with the geographical region. The second AI model 210 is configured to generate the second emission level 216 associated with the emission of the gas by the specific power plant 224 within the first predefined time period. In an example, the first AI model 208 generates the first emission level 214 associated with the geographical region. For instance, the first AI model 208 generates the first emission level 214 associated with the specific power plant 224.

In one embodiment, the second AI model 210 is configured to receive the first emission level 214 associated with a geographical region. This first emission level 214 is generated by the first AI model 208, which analyzes the emissions data and provides insights into the gas emissions from the specific power plant 224. The second AI model 210 then utilizes the first emission level 214 to generate the second emission level 216 which reflects the emissions of gas by the specific power plant 224 within a first predefined time period. For instance, if the first AI model 208 determines the initial emission level of CO₂ in the geographical region on a day. Further, the second AI model 210 processes this information to calculate the total emission of gas by the specific power plant 224 associated with the geographical region within the first predefined time period, such as, but not limited to, on a particular day or in a week.

In an exemplary embodiment, the second AI model 210 is configured to generate the second emission level 216 associated with the CO₂ by the specific power plant 224 within a first predefined time period such as, but not limited to daily. In an example, the second AI model 210 is configured to estimate the concentration of CO₂ that would be present in the atmosphere in the absence of any new emissions from specific sources. The second AI model 210 uses historical data, satellite observations, and atmospheric measurements to build a comprehensive picture of baseline CO₂ levels emitted by the specific power plant 224 in the first predefined time period, say a day. By providing this baseline, the second AI model 210 helps in distinguishing the additional CO₂ emissions from localized sources.

In an example, the second AI model 210 quantifies the concentration of carbon dioxide (CO₂) in the atmosphere. The second AI model 210 is designed to account for the background levels of CO₂ that exist in the environment before adding emissions from specific sources, such as power plants. The background emission model establishes a baseline for CO₂ levels, which helps in isolating and measuring the additional CO₂ emissions from local sources. The background level of CO₂ levels refers to the natural and pre-existing concentration of CO₂ in the atmosphere. The background level of CO₂ levels is influenced by a variety of factors, including natural processes like respiration, decay, and ocean-atmosphere exchanges, as well as human activities such as deforestation and industrial emissions. Since CO₂ has a long atmospheric lifetime, it remains in the air for extended periods, making the background concentration stable over time but subject to seasonal and regional variations.

In one embodiment, the second AI model 210 integrates a wide range of data sources, including historical CO₂ concentrations, meteorological data (e.g., wind speed, temperature, humidity), and geographical information. Satellite observations are particularly valuable as they provide a global view of CO₂ distributions and help in understanding the spatial and temporal variations in background levels. Calibration is crucial for ensuring the accuracy of the second AI model 210. This process involves adjusting the model parameters to match observed data. For example, if satellite data indicates higher CO₂ levels in a specific region, the second AI model 210 is recalibrated to reflect these observations. In an embodiment, the second AI model 210 estimates the background level of CO₂ by analyzing historical data and current atmospheric conditions. It separates the baseline CO₂ concentration from the variations caused by local emissions. This is done through statistical and computational methods that account for the natural variability in CO₂ levels. Further, the second AI model 210 is configured to generate the second emission level 216 associated with the emission of the gas by the power plant within the first predefined time period. In an example, once the background CO₂ levels are established, the second AI model 210 calculates the additional CO₂ emissions, referred to as delta XCO₂ (ΔXCO₂). This is the difference between the observed CO₂ concentration and the estimated background level. ΔXCO₂ represents the contribution of local sources, such as power plants, to the overall CO₂ concentration within the first predefined time period such as a daily time period.

Further, the system 202 is configured to generate the third emission level 218 based on the second emission level 216. The third emission level 218 is associated with the emission of the gas by the specific power plant 224 within each time period of a plurality of second predefined time periods. The first predefined time period comprises the plurality of the second predefined time periods. In an embodiment, the third emission level 218 is generated based on an application of a dispersion model 404 on the second emission level 216. In an example, the dispersion model 404 generates the third emission level 218 by simulating how pollutants disperse from a power plant based on the second emission level 216. The dispersion model 404 incorporates environmental factors such as wind speed, temperature, humidity, and the second emission level 216 to predict the concentration of emission of gas over time and distance. The dispersion model 404 is calibrated based on one or more environmental factors associated with the geographical region.

In an embodiment, the dispersion model 404 is a mathematical and computational tool used to simulate the spread and dispersion of gas in the atmosphere of the geographical region. The dispersion model 404 works by solving mathematical equations that describe the physical processes governing environmental factors, such as gas transport, including advection, diffusion, and chemical reactions. The dispersion model 404 utilizes environmental factors such as meteorological conditions for example, but not limited to, wind speed, wind direction, temperature, and humidity significantly influence how gas disperses in the geographical region. For instance, high wind speeds can lead to greater dispersion and lower gas concentrations at ground level, whereas low wind speeds result in higher concentrations and localized pollution. Temperature inversions, where warmer air traps pollutants close to the ground, can also affect the dispersion patterns of the gas in the geographical region. The dispersion model 404 incorporates these variables to simulate realistic gas spread. The dispersion model 404 utilizes other factors such as, but not limited to, topography, or the physical features of the geographical region. For example, a valley might trap gas, leading to higher concentrations, whereas a mountainous region might cause pollutants to disperse more rapidly. The dispersion model 404 adjusts for these variations by incorporating data on local terrain.

The dispersion model 404 also includes other factors such as the nature of emission sources, including their height, volume, and type of emissions, which also affect dispersion. Tall stacks release gas higher into the atmosphere, where they are more widely dispersed, while ground-level sources might result in more concentration of gas. The dispersion model 404 adjusts the predictions based on these characteristics to reflect the true dispersion behavior of the gas in the geographical region.

In an example, the calibration of the dispersion model 404 involves comparing the dispersion model 404 predictions with actual observed data from monitoring stations. By fine-tuning the dispersion model 404 parameters based on this comparison, the dispersion model 404 reflects real-world conditions as closely as possible.

In an embodiment, the dispersion model 404 generates the third emission level 218 by applying these calibrated parameters. For example, consider a coal-fired power plant located in a coastal region, emitting gases such as CO₂, NO₂, and SO₂. The system 202 calculates the second emission level 216 using the second AI model 210, revealing emissions of 500 tons of CO₂, 50 tons of SO₂, and 30 tons of NOₓ at the daily level. This time period is defined as one day, divided into sub-daily intervals for detailed analysis. To generate the third emission level 218, the system 202 applies the dispersion model 404, which incorporates environmental factors like wind speed (10 mph), wind direction (southwest), temperature (60° F. to 75° F.), and humidity (70%). The dispersion model 404 predicts emissions dispersion over the day, yielding results such as 20 tons of CO₂ in a sub-daily time period. The sub-daily time period may correspond to the second predefined time periods of, for example, one hour.

FIG. 5A is a diagram that illustrates a block diagram 500A of an exemplary operation for determination of the calibration factor data 220, in accordance with an example embodiment of the present disclosure. In an example, the steps of the exemplary operation may be implemented by the system 202. FIG. 5A is described in conjunction with elements of the FIG. 2, FIG. 3A, FIG. 3B, and FIG. 4.

In one embodiment, the system 202 is configured to input the profile data 304 associated with the specific power plant 224 to the third AI model 212. In an example, the profile data 304 is generated by the first AI model 208. The profile data 304 may include a type of power plant, its operational characteristics, and the identified segmented area 308. The profile data 304 provides a foundational understanding of the facility's emissions behavior, which is utilized for accurate modeling.

Further, the system 202 is configured to input the third emission level 218 within each time period of the plurality of second predefined time periods to the third AI model 212. The third emission level 218 is derived from a dispersion model, which simulates how pollutants disperse in the atmosphere based on various factors, including meteorological conditions and emission sources. The third emission level 218 is calculated for each time period within a predefined set of second time periods, allowing the system 202 to analyze emission trends over time. This temporal analysis is crucial for understanding how emissions fluctuate due to operational changes or environmental factors.

Further, the system 202 is configured to receive ground truth emission data 502 associated with the specific power plant 224. In an example, the system 202 then receives ground truth emission data 502 associated with the specific power plant 224. The ground truth emission data 502 is collected from direct measurements or reliable monitoring systems that provide actual historical emissions levels associated with the specific power plant 224. The ground truth emission data 502 serves as a benchmark for validating the predictions of the third AI model 212, ensuring that the system 202 accurately assesses the performance of its emission estimates.

Further, the system 202 is configured to input the ground truth emission data 502 to the third AI model 212. In an example, the ground truth emission data 502 allows the third AI model 212 to evaluate its predictions against the actual emissions recorded. By incorporating this real-world data, the system 202 identifies discrepancies between predicted and observed emissions, which is utilized for refining the third AI model 212.

Further, the system 202 is configured to determine the calibration factor data 220 based on the application of the third AI model 212 on the profile data 304, the third emission level 218, and the ground truth emission data 502. In an example, using these three inputs, the third AI model 212 applies statistical analysis to calculate the calibration factor data 220, which adjusts the predicted emissions of the gas by the specific power plant 224 to align more closely with the actual observed values. This calibration factor data 220 is used for refining the emissions estimates produced by the dispersion model 404, enhancing their accuracy and reliability. The fourth emission level 222 is a more precise emissions level associated with the emission of gas by the specific power plant 224.

Furthermore, the calibration factor data 220 is used to generate the fourth emission level 222, associated with the gas emissions from another specific power plant 224. By applying the calibration factor data 220 to the emissions data of this different facility, the system 202 adjusts the predicted emissions to ensure they accurately reflect the actual gas emissions.

FIG. 5B is a diagram that illustrates a method flow diagram 500B that depicts the estimation of emission data associated with the emission of gas by each of a set of power plants, in accordance with an embodiment of the disclosure. In an example, the steps of the exemplary operation may be implemented by the system 202. FIG. 5B is explained in conjunction with elements from FIG. 1, FIG. 2, FIG. 3A, FIG. 3B, FIG. 4, and FIG. 5A.

At 504, power plant data associated with each of a plurality of power plants is received. In one embodiment, the system 202 is configured to receive power plant data associated with each power plant of the plurality of power plants. For example, each power plant of the plurality of power plants is associated with a geographical location. The power plant data comprises imagery data of the geographical location associated with each power plant of the plurality of power plants. In one embodiment, the plurality of power plants is inclusive or exclusive of the specific power plant 224. In an example, consider a scenario where the system 202 receives power plant data associated with the plurality of power plants, for example, a first coal-fired power plant, a second coal-fired power plant, a third coal-fired power plant, a fourth natural gas plant, and a fifth solar power plant. The imagery data for each plant may reveal distinct features. The coal-fired plant might show large coal storage areas and emissions stacks, while the natural gas facility could display gas turbines and a more compact layout. In contrast, the solar power plant would be characterized by extensive solar panels and minimal emissions. By analyzing this imagery data, the system 202 gathers information about the geographical context of each power plant, including surrounding infrastructure, land use, and potential environmental impacts. This information is utilized for identifying similarities and differences between the specific power plant 224 and the plurality of power plants. Additionally, the location data 302 allows the system 202 to consider local meteorological conditions, terrain features, and regulatory requirements that may affect emissions.

At 506, a set of power plants from the plurality of power plants is identified. In one embodiment, the system 202 is configured to identify a set of power plants from the plurality of power plants based on at least one similarity criterion between the power plant data associated with each power plant of the plurality of power plants and the profile data 304. In an example, the system 202 is configured to identify a set of power plants from the plurality of power plants based on a similarity of the profile data 304 associated with the specific power plant 224 and the power plant data associated with the plurality of power plants.

For example, the profile data 304 associated with the specific power plant 224 shows that the type of the specific power plant 224 is a coal-fired power plant and the segmented area 308 is associated with the specific power plant 224. Further, the system 202 is configured to identify the set of power plants based on the profile data 304 being similar to the power plant data. For instance, the system 202 identifies that the second coal-fired power plant and the third coal-fired power plant have similar power plant data as the profile data 304 owing to a same type of fuel, i.e., coal, being used for generating energy. Subsequently, the set of power plants may include the second coal-fired power plant and the third coal-fired power plant. In this example, the system 202 detects that both the second coal-fired power plant and the third coal-fired power plant share similar characteristics and operational data with the specific power plant 224 associated with the profile data 304. This similarity may encompass aspects such as emissions patterns, operational efficiency, type of fuel, an amount of energy being generated, and geographical location. As a result, the system 202 creates a set of power plants that includes the second coal-fired power plant and the third coal-fired power plant.

At 508, emission data associated with the emission of the gas by each power plant of a set of power plants is estimated based on the calibration factor data 220. In an embodiment, the system 202 is configured to estimate the emission data associated with the emission of the gas by each power plant of the set of power plants based on the calibration factor data 220. In an example, the system 202 utilizes the determined calibration factor data 220 for the specific power plant 224 associated with the profile data 304 to estimate the emission data associated with the emission of the gas by the set of power plants. For instance, the calibration factor data 220 of the specific power plant 224 associated with the profile data 304 is used to estimate the emission data from the second coal-fired power plant and/or the third coal-fired power plant.

FIG. 5C is a diagram 500C that illustrates an exemplary operation for determination of the calibration factor data 220 for one or more sets of power plants, in accordance with an example embodiment of the present disclosure. In an example, the steps of the exemplary operation may be implemented by the system 202. FIG. 5A is described in conjunction with elements of the FIG. 2, FIG. 3A, FIG. 3B, FIG. 4, FIG. 5A, and FIG. 5B.

The system 202 is configured to analyze the power plants in greater detail by identifying specific sets based on their similarities. In this regard, the system 202, specifically the first AI model 208, is configured to determine first profile data 512 associated with a first set of power plants 510, and second profile data 516 associated with a second set of power plants 514. Each power plant within the first set of power plants 510 exhibits comparable profile data, for example, the profile data associated with the each power plant of the first set of power plant 510 are associated with similar type (e.g., coal-fired power plant, natural gas power plant, or renewable power plant, producing a same or similar amount of energy, operating at similar efficiency, etc.). Similarly, the profile data associated with each power plant of the first set of power plant 510 may indicate a segmented area corresponding to the each power plant in the first set of power plants 510. For example, such segmented area of each power plant in the first set of power plants 510 may be similar to the segmented area 308.For example, the first set of power plants 510 may consist of three coal-fired facilities located in three geographical locations. By analyzing their imagery data and operational characteristics, the system 202 identifies that they have comparable emissions sources, such as coal storage areas and combustion units. This similarity in profile data allows the system 202 to treat these power plants as a cohesive group for further analysis. Similarly, the system 202, specifically the first AI model 208, determines the second profile data 516 associated with the second set of power plants 514. The second set of power plants 514 includes power plants of a different type, such as natural gas power plants, which share comparable profile data among themselves. Details of determining profile data of a power plant are described in conjunction with, for example, FIG. 3A.

Once the sets of power plants have been identified based on their profile data, the system 202, specifically the third AI model 212, is configured to determine the calibration factor data 220 for at least one power plant within each set of the sets of power plants. Pursuant to the present example, the third AI model 212 is configured to determine first calibration factor data 518 associated with a power plant in the first set of the power plants 510 based on the first profile data 512. Similarly, the third AI model 212 is configured to determine second calibration factor data 520 associated with a power plant in the second set of the power plants 514 based on the second profile data 516. These calibration factor data serve as a reference point for adjusting emissions estimates to align more closely with actual observations. Details associated with determining calibration factor data based on profile data are described in conjunction with, for example, FIG. 5A.

Finally, the system 202, specifically the third AI model 212, utilizes the respective calibration factor data to determine the emission data for each power plant within its corresponding set of power plants. The first calibration factor data 518 is applied to each power plant in the first set of power plants 510 to estimate their emissions levels, while the second calibration factor data 520 is used for each power plant in the second set of power plants 514. By applying the appropriate calibration factor to each set of power plants, the system 202 ensures that the emissions estimates are tailored to the specific characteristics of the power plants, enhancing the accuracy of the predictions.

In an example, the first calibration factor data 518 may be applied to estimate emissions from a particular power plant in the first set of power plants 510. In such a case, the first calibration factor data 518 may be updated or fine-tuned based on specific profile data associated with the particular power plant. In an example, the first calibration factor data 518 may be used for estimating the emissions of the particular power plant accurately.

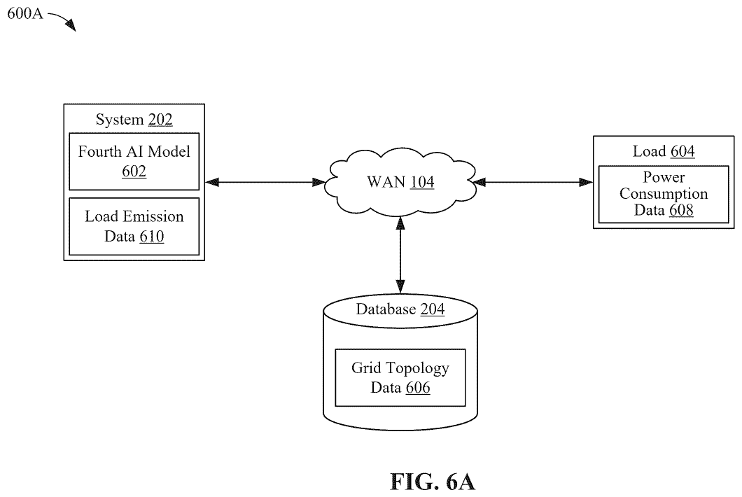

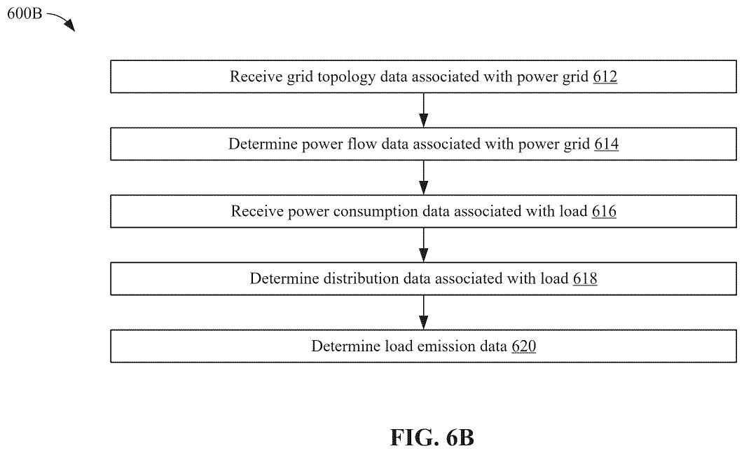

FIG. 6A is a diagram that illustrates a network environment 600A in which the system 202 is implemented for determination of load emission data 610 associated with a load 604, in accordance with an embodiment of the present disclosure. FIG. 6A is described in conjunction with FIG. 2. The network environment 600A includes the system 202 and the database 204. The network environment 200 may further include the WAN 104 of FIG. 1. The system 202 includes a fourth AI model 602. The database 204 may be configured to store the grid topology data 606. The network environment 600A further includes a load 604. In an embodiment, the network environment 300 may be an exemplary embodiment of, or may be connected to the network environment 200 of FIG. 2.

In one embodiment, the grid topology data 606 is stored in the database 204. the grid topology data 606 includes a detailed structure and connections within an electrical power grid, utilized for understanding and managing electricity flow. The grid topology data 606 includes information of components such as, but not limited to, nodes, which represent generators, i.e., power plants, loads, and substations, and edges, which are the transmission lines linking these nodes. The grid topology data 606 includes transmission line parameters including conductance, susceptibility, impedance, and capacity, for determining how power is transmitted across the grid. Additionally, the grid topology data 606 includes information of the bus, which serves as junction points where multiple lines or generators connect, and switches and transformers manage electrical flow and voltage levels. The grid topology data 606 is used for power flow analysis, which helps identify how electricity moves from generators to consumers and optimizes network performance.

In one embodiment, a power flow solver may be used to analyze and utilize the grid topology data 606 to determine electricity flow to the load 604. The power flow solver is an analytical tool that may be used to analyze and manage the flow of electrical power through the power grid. The power solver calculates the steady-state operating conditions of the grid by processing inputs such as grid topology, generation capacities, load demands, and transmission line characteristics like resistance and reactance. The power solver utilizes mathematical methods, such as, but not limited to, a Newton-Raphson method, to iteratively refine estimates of voltage levels and power flows until a stable solution is reached. Other methods, such as the Gauss-Seidel or Fast Decoupled method, may also be used depending on the specific needs and efficiency requirements. The output from a power flow solver provides critical insights, including voltage levels at various nodes, real and reactive power flows through transmission lines, and energy losses due to line resistance. The power flow in a transmission line Lᵢⱼ is given by:

$${P}_{i j} = \frac{{V}_{i}^{2}}{{X}_{i j}} - {V}_{i} {V}_{j} ( {G}_{i j} cos ( {θ}_{i j} ) + {B}_{i j} sin ( {θ}_{i j} ) ) \qquad ( 1 )$$

where,
   Pᵢⱼ indicates real power flow on the line between bus ‘i’ to bus ‘j’,
   Xᵢⱼ indicates impedance between the bus ‘i’ to bus ‘j’,
   Vᵢ indicates voltage at bus ‘i’,
   Vⱼ indicates the voltage at bus ‘j’,
   Gᵢⱼ indicates conductance of the transmission line between the bus ‘i’ to bus ‘j’,
   Bᵢⱼ indicates the susceptance of the transmission line between the bus ‘i’ to bus ‘j’,
   and
   θᵢⱼ indicates the phase angle difference between buses i & j.

The fourth AI model 602 utilizes analytical tools designed to trace and allocate emissions of gas from the specific power plant 224 to end consumers within a power grid. The fourth AI model 602 determines how emissions of gas from various generators, i.e., the specific power plant 224 translate into the energy consumed by different loads, such as commercial buildings or industrial facilities. The fourth AI model 602 analyzes grid topology, which maps the connections between power plants and consumer loads, including the physical properties of transmission lines. This topology helps in understanding how power flows from generators to consumers.

The fourth AI model 602 is configured to determine the distribution of power, using the power flow solver. The power flow solver is configured to calculate how much power each generator supplies to each load, considering factors such as generation capacities and load 604 demands. This data is used for accurate emission allocation. Each generator's emission profile is established based on its technology, fuel type, and operational efficiency, providing a basis for quantifying emissions produced. With both power flow and emission profiles in hand, the fourth AI model 602 estimates emissions to specific loads based on the proportion of energy they receive from different generators.

In an embodiment, the system 202 is configured to determine load emission data 610 by integrating grid topology data 606 and power consumption data 608 using the fourth AI model 602. The fourth AI model 602 may utilize the grid topology data 606 to map the connections between the one or more power plants and consumer loads, such as the load 604. The mapping may also include transmission lines and their characteristics like conductance and impedance. Further, the fourth AI model 602 utilizes the power consumption data 608, reflecting the electricity usage of the load 604 at different time instants and the fourth emission levels of each of the one or more power plants to accurately determine the emission profile of the load 604. In an example, the power consumption data 608 is gathered through energy meters installed at consumer sites. The fourth AI model 602 processes this information, integrating grid topology with power consumption and the fourth emission levels of each power plant. The fourth AI model 602 performs power flow analysis to determine how much power the load 604 receives from different generators, and then allocates emissions based on these power flows. The fourth AI model 602 outputs the load emission data 610 at each time instant of the plurality of time instant. The result is a comprehensive set of load emission data, which specifies the gas emissions associated with the load 604 at each time instant.

FIG. 6B is a diagram that illustrates a method flow 600B for determination of the load emission data 610 associated with the load 604, in accordance with an embodiment of the disclosure. In an example, the steps of the exemplary operation may be implemented by the system 202. FIG. 6B is explained in conjunction with elements of FIG. 1, FIG. 2, FIG. 3A, FIG. 3B, FIG. 4, FIG. 5A, FIG. 5B, and FIG. 6A.

At 612, the grid topology data 606 associated with a power grid is received. In one embodiment, the system 202 is configured to receive the grid topology data 606 associated with the power grid. The power grid is supplied by at least the specific power plant 224 for which the fourth emission level 222 is determined. In an example, the grid topology data 606 provides a detailed map of the power grid's structure, including a layout of nodes and edges of the power grid. The nodes represent critical components such as power plants, substations, and consumer loads, while the edges denote the transmission lines connecting the nodes. For instance, the system 202 specifically receives information about how the power grid is organized and interconnected, including the locations and capacities of the power plants that supply electricity to the grid.

At 614, power flow data associated with the power grid is determined. In one embodiment, the system 202 is configured to determine the power flow data associated with the power grid. The power flow data is used for understanding how electricity moves through the power grid, providing insights into the power distribution and power consumption of power across various nodes. In one embodiment, the system 202 collects real-time data from sensors and smart meters located throughout the grid, which monitor voltage levels, current flow, and power consumption at different points. For example, the system 202 analyzes the power flow data from a network of substations, transformers, and distribution lines to assess the flow of electricity from power generation sources to end users. The power flow data reveals patterns in energy usage, such as peak demand periods when consumption is highest.

At 616, the power consumption data 608 associated with the load 604 is received. In one embodiment, the system 202 is configured to receive the power consumption data 608 associated with the load 604. The load 604 is connected to the power grid. The power consumption data 608 is used for understanding how much electricity is being consumed by the load 604 at various time instants. For example, the load 604 may be a residential load, a commercial load, or an industrial load. For example, consider a scenario where an industrial facility is connected to the power grid. The system 202 collects the power consumption data 608 from smart meters installed in the industrial facility, which continuously monitors and reports energy usage in real-time. In this case, the power consumption data 608 might indicate that the industrial facilities consume an average of 20000 kilowatts during peak hours and 10000 kilowatts during off-peak hours. This information allows the system 202 to analyze consumption patterns, identify peak demand periods, and assess the load 604 on the power grid.

At 618, the distributed data associated with the load 604 is determined. In one embodiment, the power grid is connected to one or more power plants comprising the specific power plant 224. Further, the system 202 is configured to determine the distribution data associated with the load 604 based on an application of the fourth AI model 602 on the grid topology data 606 and the power consumption data 608. The distribution data indicates a distribution of a total amount of power consumed by the load 604 over each power plant of the one or more power plants connected to the power grid. In an example, the system 202 determines the distribution data associated with the load 604 connected to the power grid. This process involves applying the fourth AI model 602 to analyze the grid topology data 606 and the power consumption data 608. The distribution data provides insights into how the total amount of power consumed by the load 604 is allocated across each of the power plants connected to the power grid. For example, consider a scenario where the industrial facility is supplied with electricity from three power plants, for example, a first power plant, a second power plant, and a third power plant. The grid topology data 606 reveals the connections and capacities of each of the three power plants, while the power consumption data 608 indicates that the total demand from the industrial facility is 20000 kilowatts (KW). The fourth AI model 602 processes this information and determines that the first power plant supplies 9000 KW, the second power plant supplies 6000 KW, and the third power plant supplies 5000 KW to the load 604.

The distribution data indicates that the first power plant, being the closest to the industrial facility and having the highest capacity, meets the largest share of the demand. The second power plant follows, and the third power plant provides the remaining supply.

At 620, the load emission data 610 is determined. In an embodiment, the system 202 is configured to determine the load emission data 610 based on the application of the fourth AI model 602 on the grid topology data 606, the power consumption data 608, and the fourth emission level 222 associated with the emission of the gas by the specific power plant 224 at each time instant of the plurality of time instants, The load emission data 610 is associated with the emission of the gas by the load 604. In an example, the system 202 is configured to determine the load emission data 610 based on the application of the fourth AI model 602, which processes the grid topology data 606, the power consumption data 608, and the fourth emission level 222 associated with the emissions of the gas by the power plants at each time instant within a defined set of time intervals. The grid topology data 606 provides insights into how power is distributed across the network, while the power consumption data 608 reflects the energy usage patterns of various loads connected to the power grid. The fourth emission level 222 indicates the total emissions resulting from the power plants at each time instant of the plurality of time instants. By integrating these data sources, the fourth AI model 602 can assess the emissions associated with the load 604, quantifying how much gas is emitted as a result of the energy consumed by the load 604.

In an embodiment, the system 202 is configured to determine the load emission data 610 based on an application of the fourth AI model 602 on the distribution data and the fourth emission level 222 associated with the emission of the gas by the specific power plant 224 at each time instant of the plurality of time instants. In an example, the system 202 is configured to determine the load emission data 610 based on the application of the fourth AI model 602 to the distribution data and the fourth emission level 222. The process is used for understanding the emissions generated by the load 604 connected to the power grid, enabling better management of environmental impacts. Consider an industrial facility relying on electricity from three power plants. The fourth emission level 222 indicates the total emission of gas produced by each of the three power plants at each time instant of the plurality of time instants, while the distribution data, derived from the fourth AI model 602, shows how much power the industrial facility consumes and how this consumption is distributed across the three power plants.

According to an example, a total power consumption of the load 604 may be 2000 kW at a first time instant, with the first power plant supplying 900 KW at the first time instant, the second power plant supplying 600 KW at the first time instant, and the third power plant supplying 500 KW at the first time instant. The fourth emission level 222 shows that the first power plant emits 1,200 tons of CO₂ at the first time instant, the second power plant emits 800 tons of CO₂ at the first time instant, and the third power plant emits 300 tons of CO₂ at the first time instant. Using this data, the fourth AI model 602 calculates the load emission data 610 by determining each power plant's emissions contribution to the overall load. For instance, the load emission data 610 for the industrial facility can be calculated as 540 tons of CO₂ from the first power plant at the first time instant, 240 tons of CO₂ from the second power plant at the first time instant, and 200 tons of CO₂ from the third power plant at the first time instant, totaling 980 tons of CO₂ at the first instant. This detailed analysis allows the system 202 to provide insights into the emissions generated by the load 604, enabling the industrial complex to implement targeted strategies for emissions reduction, optimize energy usage, explore renewable energy options, and enhance compliance with environmental regulations, supporting sustainable practices within the industrial sector.

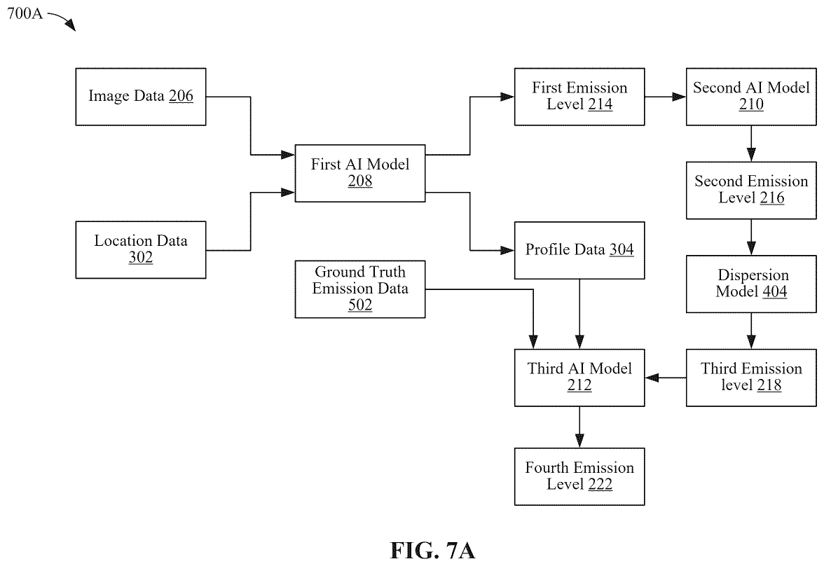

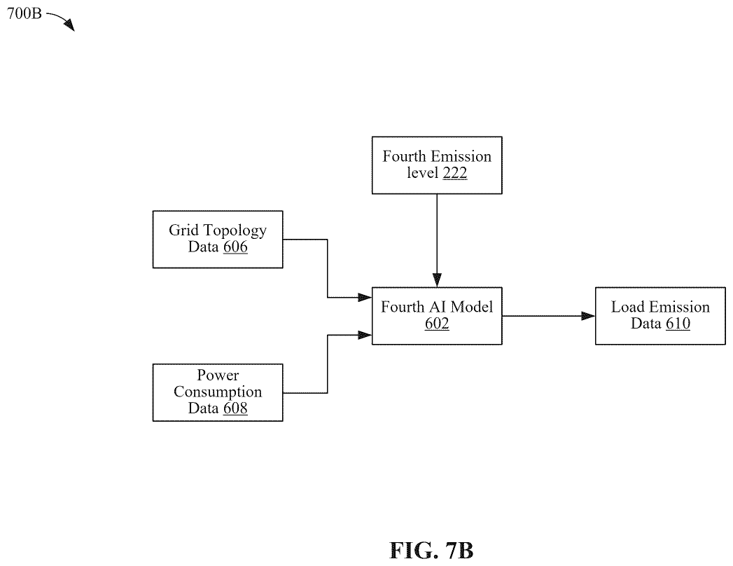

FIG. 7A is a block diagram that 700A illustrates an exemplary operation for the generation of fourth emission level 222 associated with the emission of the gas by the specific power plant 224, in accordance with an example embodiment of the present disclosure. In an example, the steps of the exemplary operation may be implemented by the system 202. FIG. 7A is described in conjunction with elements of FIG. 2, FIG. 3A, FIG. 3B, FIG. 4, FIG. 5A, FIG. 5B, FIG. 5C, FIG. 6A and FIG. 6B.

In one embodiment, the system 202 receives image data 206 and location data 302 from one or more sources. The image data 206 encompasses the geographical region where the specific power plant 224 is situated, while the location data 302 includes the coordinates of the geographical region. The first AI model 208 processes the image data 206 and the location data 302 to output the first emission level 214 and the profile data 304 associated with the specific power plant 224. The first emission level 214 indicates the total amount of gas present in the geographical area, providing a quantitative measure of emissions. Additionally, the specific power plant 224 profile includes information, such as a type of power plant, and a segmented area associated with the specific power plant 224. The detailed operational data enables the system 202 to assess emissions accurately and understand the environmental context of the specific power plant 224. The detailed operation of the first AI model 208 is described in conjunction with the FIG. 3A and FIG. 3B.

Further, the second AI model 210 is configured to determine the second emission level 216 associated with the emission of the gas by the specific power plant 224 in the first predefined time period. The second AI model 210 determines the amount of gas emitted by the specific power plant 224 in the first predefined time period based on the first emission level 214. The second AI model 210 is configured to determine the background level of gas in the atmosphere, i.e., an amount of gas present in the atmosphere before the first predefined time period, say a day under consideration. Thereafter, the second AI model 210 determines the second emission level, i.e., the amount of gas emitted by the specific power plant 224 within the first predefined time period, for example, the day.

In an example, the second AI model 210 first assesses the background level of gas present in the atmosphere, which serves as a baseline for comparison. By understanding the ambient concentrations of gases, the second AI model 210 accurately isolates the emissions attributable to the specific power plant 224. Once the background levels are established, the second AI model 210 generates the second emission level 216 associated with the emission of the gas by the specific power plant 224 in the first predefined time period. This process involves analyzing various data inputs, such as real-time monitoring data, historical emissions data, and environmental factors that may influence gas dispersion. The detailed operation of the second AI model 210 is described in conjunction with FIG. 4.

Thereafter, the dispersion model 404 is configured to determine the third emission level 218 based on the second emission level 216. The third emission level 218 is associated with the emission of the gas by the specific power plant 224 within each time period of a plurality of second predefined time periods. The first predefined time period comprises the plurality of the second predefined time period. The third emission level 218 is specifically associated with the emissions of gas from the specific power plant 224 over each time period within a defined set of second predefined time periods. By utilizing the second emission level 216 as a foundation, the dispersion model 404 simulates how the emitted gases disperse in the atmosphere, taking into account various environmental factors such as wind speed, temperature, and humidity. The detailed operation of the dispersion model 404 is described in conjunction with FIG. 4.

Further, the third AI model 212 is configured to determine the calibration factor data 220 by applying its algorithms to the third emission level 218 associated with each time period of the plurality of second predefined time periods. This calibration factor data 220 provides insights into the emissions of the gas by the specific power plant 224 within the first predefined time period. The calibration factor data 220 includes plurality of calibration values that correspond to various time instants within this predefined time period, allowing for a detailed temporal analysis of emissions. To generate the calibration factor data 220, the third AI model 212 takes as input the profile data 304 related to the specific power plant 224, the third emission level 218, and the ground truth emission data 502. By analyzing these inputs, the third AI model 212 produces the calibration factor data that helps adjust the predicted emissions to align more closely with actual observed values. Details of the third AI model 212 to generate the calibration factor data 220 are described in conjunction with FIG. 5A.

In various embodiments, the system 202 is configured to estimate a fourth emission level based on the calibration factor data 220, the fourth emission level 222 is associated with the emission of the gas by the specific power plant 224 at each time instant of the plurality of time instants The detailed operation of the third AI model 212 is described in conjunction with FIG. 4.

FIG. 7B is a block diagram 700B that illustrates an exemplary operation for the generation of the load emission data 610 associated with the load 604, in accordance with an example embodiment of the present disclosure. In an example, the steps of the exemplary operation may be implemented by the system 202. FIG. 7A is described in conjunction with elements of FIG. 2, FIG. 3A, FIG. 3B, FIG. 4, FIG. 5A, FIG. 5B, FIG. 5C, FIG. 6A, FIG. 6B, and FIG. 7A.

In one embodiment, the fourth AI model 602 is configured to determine the load emission data 610 by utilizing the grid topology data 606, the power consumption data 608, and the fourth emission level 222. The fourth AI model 602 analyzes the interaction between the grid's structure and the power consumption patterns to assess the emissions associated with the load 604. By applying the fourth AI model 602 to the grid topology data, the fourth AI model 602 understands how energy flows through the network and identifies the emission contributions from various loads at each time instant within a defined set of time intervals. The fourth emission level 222 represents the emissions of gas by the specific power plant 224 during these intervals. By integrating this information, the fourth AI model 602 calculates the load emission data 610, which quantifies the emissions produced by the energy consumed by the loads connected to the grid. This approach allows for a comprehensive assessment of emissions, linking power generation to consumption, and supporting more effective emissions management strategies. Detailed operation of the fourth AI model 602 is described in conjunction with, for example, FIG. 6A and FIG. 6B.

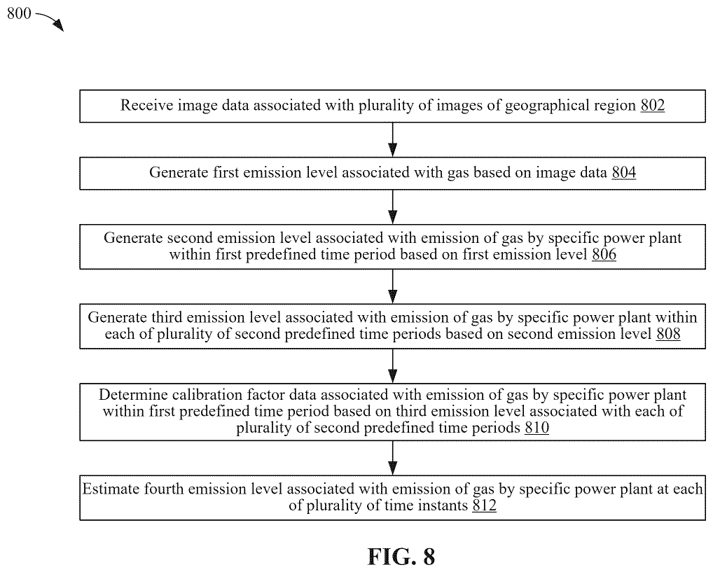

FIG. 8 is a diagram that illustrates a flowchart 800 of an exemplary method for estimating real-time emissions of a specific power plant 224, in accordance with an embodiment of the disclosure. In an example, the steps of the exemplary operation may be implemented by the system 202. FIG. 8 is described in conjunction with elements of FIG. 2, FIG. 3A, FIG. 3B, FIG. 4, FIG. 5A, FIG. 5B, FIG. 5C, FIG. 6A, FIG. 6B, FIG. 7A, and FIG. 7B.

At 802, image data associated with a plurality of images of a geographical region is received. In an embodiment, the system 202 is configured to receive the image data 206 associated with the plurality of images 306 of the geographical region. The geographical region includes a specific power plant 224. The image data 206 indicates emission data associated with a gas.

At 804, a first emission level associated with the gas based on the image data is generated. In an embodiment, the system 202 is configured to generate the first emission level 214 associated with the gas based on the image data 206. The first emission level 214 is generated using the first AI model 208. In an example, the first AI model 208 is reconfigured using a loss function associated with the received image data 206 and labeled image data and outputs a specific power plant 224 profile comprising at least one of a type of the power plant, or the segmented area 308 of the specific power plant 224 within the plurality of images 306, and the labeled image data comprises at least one labeled image associated with the received image data 206.

At 806, a second emission level associated with the emission of the gas is generated. In an embodiment, the system 202 is configured to generate the second emission level 216 based on the first emission level 214. The second emission level 216 is associated with the emission of the gas by the specific power plant 224 within a first predefined time period. In an example, the second AI model 210 generates the second emission level 216 for the specific power plant 224.

At 808, a third emission level associated with the emission of the gas is generated. In an embodiment, the system 202 is configured to generate the third emission level 218 based on the second emission level 216. The third emission level 218 is associated with an emission of the gas by the specific power plant 224 within each of a plurality of second predefined time periods. The first predefined time period includes the plurality of the second predefined time periods. In an example, the dispersion model 404 determines the third emission level 218 associated with the gas within each of the plurality of second predefined time periods.

At 810, calibration factor data associated with the emission of the gas is determined. In an embodiment, the system 202 is configured to determine the calibration factor data 220 based on the third emission level 218 associated with each time period of the plurality of second predefined time periods. The calibration factor data 220 is associated with the emission of the gas by the specific power plant 224 within the first predefined time period. The calibration factor data 220 includes a plurality of calibration values corresponding to a plurality of time instants within the first predefined time period. In an example, the system 202 determines the calibration factor data 220 using the third AI model 212.

At 812, a fourth emission level is estimated. In an embodiment, the system 202 is configured to estimate the fourth emission level 222 based on the calibration factor data 220. The fourth emission level 222 is associated with the emission of the gas by the specific power plant 224 at each of the plurality of time instants.

Various embodiments of the disclosure may provide a non-transitory computer readable medium and/or storage medium having stored thereon, instructions executable by a machine and/or a computer to operate a system (e.g., the system 202) for real-time emission profiling of one or more industries. The instructions may cause the machine and/or computer to perform operations that include receiving, by a computer, image data associated with a plurality of images of a geographical region. The geographical region comprises a specific power plant, and the image data indicates emission data associated with a gas. The operations further include generating, using a first artificial intelligence (AI) model, a first emission level associated with the gas based on the image data. The operations further include generating, using a second AI model, a second emission level associated with an emission of the gas by the specific power plant within a first predefined time period based on the first emission level. The operations include generating a third emission level associated with an emission of the gas by the specific power plant within each of a plurality of second predefined time periods based on the second emission level. The first predefined time period comprises the plurality of the second predefined time period. The operations further include determining, a third AI model, calibration factor data associated with the emission of the gas by the specific power plant within the first predefined time period based on the third emission level associated with each of the plurality of second predefined time periods. The calibration factor data comprises a plurality of calibration values corresponding to a plurality of time instants within the first predefined time period. The operations further estimate a fourth emission level associated with the emission of the gas by the specific power plant at each of the plurality of time instants, based on the calibration factor data.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving, by a computer, image data associated with a plurality of images of a geographical region,
wherein the geographical region comprises a specific power plant,
wherein the image data indicates emission data associated with a gas, and
wherein the emission data corresponds to specific wavelength ranges in an electromagnetic spectrum;
generating, by the computer using a first artificial intelligence (AI) model, a first emission level associated with the gas based on the specific wavelength ranges indicated in the image data, wherein the first emission level indicates a total amount of the gas present in the geographical region;
generating, by the computer using a second AI model, a second emission level based on the first emission level, wherein the second emission level is associated with an emission of the gas by the specific power plant within a first predefined time period;
generating, by the computer, a third emission level based on the second emission level,
wherein the third emission level is associated with the emission of the gas by the specific power plant within each time period of a plurality of second predefined time periods, and
wherein the first predefined time period comprises the plurality of second predefined time periods;
receiving, by the computer, ground truth emission data that comprises an actual observed emission level associated with the specific power plant;
inputting, by the computer to a third AI model, the ground truth emission data, and the third emission level associated with each time period of the plurality of second predefined time periods;
determining, by the computer using the third AI model, calibration factor data based on the inputting of the ground truth emission data, and the third emission level associated with each time period of the plurality of second predefined time periods,
wherein the calibration factor data is associated with the emission of the gas by the specific power plant within the first predefined time period, and
wherein the calibration factor data comprises a plurality of dynamic calibration values continuously varying over each time instant of a plurality of time instants within the first predefined time period;
adjusting, by the computer, the third emission level based on the plurality of dynamic calibration values; and
estimating, by the computer, a fourth emission level based on the adjusting of the third emission level,
wherein the fourth emission level is associated with the emission of the gas by the specific power plant at each time instant of the plurality of time instants, and
wherein the fourth emission level is closer to the actual observed emission level than the third emission level.

2. The computer-implemented method of claim 1, wherein the first AI model is a geospatial foundational model (GFM).

3. The computer-implemented method of claim 1, wherein the image data indicates location data associated with the plurality of images and a timestamp associated with the plurality of images, the computer-implemented method further comprising:
reconfiguring, by the computer, the first AI model based on the image data and a loss function associated with the image data; and
determining, by the computer using the first AI model, profile data associated with the specific power plant based on the image data, wherein the profile data comprises at least one of a type or a segmented area within the plurality of images associated with the specific power plant.

4. The computer-implemented method of claim 3, wherein the loss function is a morphological loss function, and wherein the morphological loss function is based on a structure of the specific power plant within the plurality of images.

5. The computer-implemented method of claim 3, further comprising:
inputting, by the computer to the third AI model, the profile data associated with the specific power plant; and
determining, by the computer using the third AI model, the calibration factor data based on the inputting of the profile data, the third emission level, and the ground truth emission data.

6. The computer-implemented method of claim 3, further comprising:
receiving, by the computer, power plant data associated with each power plant of a plurality of power plants, wherein the power plant data comprises imagery data of a geographical location associated with each power plant of the plurality of power plants, and wherein the plurality of power plants is inclusive or exclusive of the specific power plant;
identifying, by the computer, a set of power plants from the plurality of power plants based on at least one similarity criterion between the power plant data associated with each power plant of the plurality of power plants and the profile data; and
estimating, by the computer, emission data associated with the emission of the gas by each power plant of the set of power plants based on the calibration factor data.

7. The computer-implemented method of claim 1, further comprising:
receiving, by the computer, grid topology data associated with a power grid, wherein the power grid is supplied by at least the specific power plant;
receiving, by the computer, power consumption data associated with a load, wherein the load is connected to the power grid; and
determining, by the computer using a fourth AI model, load emission data based on the grid topology data, the power consumption data, and the fourth emission level associated with the emission of the gas by the specific power plant at each time instant of the plurality of time instants, wherein the load emission data is associated with the emission of the gas by the load.

8. The computer-implemented method of claim 7, wherein the power grid is connected to one or more power plants comprising the specific power plant, and wherein the computer-implemented method further comprises:
determining, by the computer using the fourth AI model, distribution data associated with the load based on the grid topology data and the power consumption data, wherein
the distribution data indicates a distribution of a total amount of power consumed by the load over each power plant of the one or more power plants connected to the power grid; and
determining, by the computer using the fourth AI model, the load emission data based on the distribution data and the fourth emission level associated with the emission of the gas by the specific power plant at each time instant of the plurality of time instants.

9. The computer-implemented method of claim 1, further comprising generating, by the computer, the third emission level based on a dispersion model, wherein the dispersion model is based on one or more environmental factors associated with the geographical region.

10. The computer-implemented method of claim 1, wherein the gas corresponds to at least one of Carbon dioxide (CO₂), Nitrogen dioxide (NO₂), or Sulphur dioxide (SO₂).

11. A computer system, comprising:
a processor set;
one or more computer-readable storage media; and
program instructions stored on the one or more computer-readable storage media executable by the processor set to cause the processor set to:
receive image data associated with a plurality of images of a geographical region, the geographical region comprising a specific power plant,
wherein the image data indicates emission data associated with a gas, location data associated with the plurality of images, and a timestamp associated with the plurality of images, and
wherein the emission data corresponds to specific wavelength ranges in an electromagnetic spectrum;
reconfigure a first artificial intelligence (AI) model based on the image data and a loss function associated with the image data;
generate a first emission level associated with the gas based on an application of the first AI model on the image data, wherein the first emission level indicates a total amount of the gas present in the geographical region;
generate a second emission level based on an application of a second AI model on the first emission level, wherein the second emission level is associated with an emission of the gas by the specific power plant within a first predefined time period;
generate a third emission level based on the second emission level,
wherein the third emission level is associated with the emission of the gas by the specific power plant within each time period of a plurality of second predefined time periods, and
wherein the first predefined time period comprises the plurality of second predefined time periods;
receive ground truth emission data that comprises an actual observed emission level associated with the specific power plant;
input, to a third AI model, the ground truth emission data, and the third emission level associated with each time period of the plurality of second predefined time periods;
determine calibration factor data based on the input of the ground truth emission data, and the third emission level associated with each time period of the plurality of second predefined time periods,
wherein the calibration factor data is associated with the emission of the gas by the specific power plant within the first predefined time period, and
wherein the calibration factor data comprises a plurality of dynamic calibration values that continuously varies over each time instant of plurality of time instants within the first predefined time period;
adjust the third emission level based on the plurality of dynamic calibration values; and
estimate a fourth emission level based on the adjustment of the third emission level,
wherein the fourth emission level is associated with the emission of the gas by the specific power plant at each time instant of the plurality of time instants, and
wherein the fourth emission level is closer to the actual observed emission level than the third emission level.

12. The computer system of claim 11, wherein the first AI model is a geospatial foundational model (GFM).

13. The computer system of claim 11,
wherein the loss function is a morphological loss function, and
wherein the morphological loss function is based on a structure of the specific power plant within the plurality of images.

14. The computer system of claim 11,
wherein the program instructions further cause the processor set to determine profile data associated with the specific power plant based on the application of the first AI model on the image data, and
wherein the profile data comprises at least one of a type or a segmented area within the plurality of images associated with the specific power plant.

15. The computer system of claim 14, wherein the program instructions further cause the processor set to:
input the profile data associated with the specific power plant to the third AI model; and
determine the calibration factor data based on the input of the profile data, the third emission level, and the ground truth emission data.

16. The computer system of claim 14, wherein the program instructions further cause the processor set to:
receive power plant data associated with each power plant of a plurality of power plants,
wherein the power plant data comprises imagery data of a geographical location associated with each power plant of the plurality of power plants, and
wherein the plurality of power plants is inclusive or exclusive of the specific power plant;
identify a set of power plants from the plurality of power plants based on at least one similarity criterion between the power plant data associated with each power plant of the plurality of power plants and the profile data; and
estimate emission data associated with the emission of the gas by each power plant of the set of power plants based on the calibration factor data.

17. The computer system of claim 11, wherein the program instructions further cause the processor set to:
receive grid topology data associated with a power grid, wherein the power grid is supplied by at least the specific power plant;
receive power consumption data associated with a load, wherein the load is connected to the power grid; and
determine load emission data based on an application of a fourth AI model on the grid topology data, the power consumption data, and the fourth emission level associated with the emission of the gas by the specific power plant at each time instant of the plurality of time instants, wherein the load emission data is associated with the emission of the gas by the load.

18. The computer system of claim 17, wherein the power grid is connected to one or more power plants comprising the specific power plant, and wherein the program instructions further cause the processor set to:
determine distribution data associated with the load based on an application of the fourth AI model on the grid topology data and the power consumption data,
wherein the distribution data indicates a distribution of a total amount of power consumed by the load over each power plant of the one or more power plants connected to the power grid; and
determine the load emission data based on an application of the fourth AI model on the distribution data and the fourth emission level associated with the emission of the gas by the specific power plant at each time instant of the plurality of time instants.

19. The computer system of claim 11,
wherein the program instructions further cause the processor set to generate the third emission level based on an application of a dispersion model, and
wherein the dispersion model is calibrated based on one or more environmental factors associated with the geographical region.

20. A computer-program product for an estimation of emission levels associated with emission of a gas by power plants, the computer-program product comprising:
one or more computer-readable storage media; and
program instructions stored on the one or more computer-readable storage media to perform operations comprising:
receiving image data associated with a plurality of images of a geographical region,
wherein the geographical region comprises a specific power plant, wherein the image data indicates emission data associated with the gas, and
wherein the emission data corresponds to specific wavelength ranges in an electromagnetic spectrum;
generating a first emission level associated with the gas based on an application of a first artificial intelligence (AI) model on the image data indicating the specific wavelength ranges, wherein the first emission level indicates a total amount of the gas present in the geographical region;
generating a second emission level based on an application of a second AI model on the first emission level, wherein the second emission level is associated with an emission of the gas by the specific power plant within a first predefined time period;
generate a third emission level based on the second emission level,
wherein the third emission level is associated with the emission of the gas by the specific power plant within each time period of a plurality of second predefined time periods, and
wherein the first predefined time period comprises the plurality of second predefined time periods;
receiving ground truth emission data that comprises an actual observed emission level associated with the specific power plant;
inputting, to a third AI model, the ground truth emission data, and the third emission level associated with each time period of the plurality of second predefined time periods;
determining calibration factor data based on the input of the ground truth emission data, and the third emission level associated with each time period of the plurality of second predefined time periods,
wherein the calibration factor data is associated with the emission of the gas by the specific power plant within the first predefined time period, and
wherein the calibration factor data comprises a plurality of dynamic calibration values that continuously varies over each time instant of a plurality of time instants within the first predefined time period;
adjusting the third emission level based on the plurality of dynamic calibration values; and
estimating a fourth emission level based on the adjusting of the third emission level,
wherein the fourth emission level is associated with the emission of the gas by the specific power plant at each time instant of the plurality of time instants, and
the fourth emission level is closer to the actual observed emission level than the third emission level.
